(19) United States
(12) Patent Application Publication
(10) Pub. No.: US 2021/0216787 A1
(43) Pub. Date: Jul. 15, 2021

(54) Methods and Systems for Presenting Image Data for Detected Regions of Interest

(71) Applicant: Google LLC, Mountain View, CA (US)

(72) Inventors: Joost van Hoof, London (GB); Navneet Dalal, Atherton, CA (US); James Edward Stewart, Mountain View, CA (US); Ting Yu, Santa Clara, CA (US); Maxime Veron, Los Altos, CA (US); George Alban Heitz, III, Mountain View, CA (US)

(73) Assignee: Google LLC, Mountain View, CA (US)

(21) Appl. No.: 17/216,345

(22) Filed: Mar. 29, 2021

Related U.S. Application Data
(63) Continuation of application No. 15/608,904, filed on May 30, 2017.

(51) Int. Cl. G06K 9/00; G08B 13/196

(52) U.S. Cl. CPC G06K 9/00771; G08B 13/19684; G08B 13/19673; G08B 13/19656; G08B 13/1966

(57) ABSTRACT

A method includes obtaining from an image sensor of a video camera a primary real-time video stream comprising images of a field of view of the video camera; identifying from the primary video stream one or more regions of interest in the field of view of the video camera; while obtaining the primary video stream, creating a first video sub-stream comprising a first plurality of images for a first one of the one or more identified regions of interest, wherein: images of the first plurality of images include image data for portions of the field of the video camera that include the first identified region of interest, and the images of the first plurality of images have fields of view that are smaller than the field of view of the video camera; and providing the first video sub-stream for display at a client device.

### RELATED APPLICATIONS

This application is a continuation of and claims the benefit of U.S. patent application Ser. No. 15/608,904, titled “Methods and Systems for Presenting Image Data for Detected Regions of Interest,” filed May 30, 2017,” the content of which is hereby incorporated herein by reference.

This application is related to the following U.S. patent applications, which are incorporated by reference herein in their entirety:

U.S. patent application Ser. No. 15/431,710, titled “Automatic Detection of Zones of Interest in a Video,” filed Feb. 13, 2017;

U.S. patent application Ser. No. 15/398,634, titled “Systems and Methods for Locating Image Data for Selected Regions of Interest,” filed Jan. 4, 2017;

U.S. patent application Ser. No. 14/738,930, titled “Methods and Systems for Presenting Multiple Live Video Feeds in a User Interface,” filed Jun. 14, 2015;

U.S. patent application Ser. No. 14/739,412, titled “Methods and Systems for Presenting Alert Event Indicators,” filed Jun. 15, 2015;

U.S. patent application Ser. No. 14/739,427, titled “Methods and Systems for Presenting a Camera History,” filed Jun. 15, 2015;

U.S. patent application Ser. No. 15/335,399, titled “Timeline-Video Relationship Presentation for Alert Events,” filed Oct. 26, 2016; and

U.S. patent application Ser. No. 15/335,396, titled “Timeline-Video Relationship Processing for Alert Events,” filed Oct. 26, 2016.

### TECHNICAL FIELD

The disclosed implementations relate generally to video monitoring, including, but not limited, to presenting image data for selected regions of interest.

### BACKGROUND

Video surveillance produces a large amount of continuous video data over the course of hours, days, and even months. In order for a video surveillance system to provide continuous video data without exceeding its network bandwidth and processing constraints, video data is sometimes streamed at an image resolution that is lower than the maximum device capabilities of the system. While continuous footage may be available in such implementations, it is often achieved at the expense of image clarity and attention on interesting activity captured in the footage.

### SUMMARY

Accordingly, there is a need for methods, devices, and systems for presenting image data for selected regions of interest. In various implementations, the disclosed functionality complements or replaces the functionality of video surveillance systems.

In accordance with some implementations, a method includes obtaining from an image sensor of a video camera a primary real-time video stream comprising images of a field of view of the video camera; identifying from the primary video stream one or more regions of interest in the field of view of the video camera; while obtaining the primary video stream, creating a first video sub-stream comprising a first plurality of images for a first one of the one or more identified regions of interest, wherein: images of the first plurality of images include image data for portions of the field of view of the video camera that include the first identified region of interest; and the images of the first plurality of images have fields of view that are smaller than the field of view of the video camera; and providing the first video sub-stream for display at a client device.

In accordance with some implementations, a video camera includes an image sensor, one or more processors, and memory storing one or more programs for execution by the processor. The one or more programs include instructions for: obtaining from the image sensor of the video camera a primary real-time video stream comprising images of a field of view of the video camera; identifying from the primary video stream one or more regions of interest in the field of view of the video camera; while obtaining the primary video stream, creating a first video sub-stream comprising a first plurality of images for a first one of the one or more identified regions of interest, wherein: images of the first plurality of images include image data for portions of the field of view of the video camera that include the first identified region of interest; and the images of the first plurality of images have fields of view that are smaller than the field of view of the video camera; and providing the first video sub-stream for display at a client device.

In accordance with some implementations, a server system has one or more processors and memory. The memory stores instructions that, when executed by the one or more processors, cause the server system to perform operations comprising: obtaining from an image sensor of a video camera a primary real-time video stream comprising images of a field of view of the video camera; identifying from the primary video stream one or more regions of interest in the field of view of the video camera; while obtaining the primary video stream, creating a first video sub-stream comprising a first plurality of images for a first one of the one or more identified regions of interest, wherein: images of the first plurality of images include image data for portions of the field of view of the video camera that include the first identified region of interest; and the images of the first plurality of images have fields of view that are smaller than the field of view of the video camera; and providing the first video sub-stream for display at a client device.

Thus, computing systems and devices are provided with more efficient methods for presenting data for selected regions of interest. These disclosed systems and devices thereby increase the effectiveness, efficiency, and user satisfaction with such systems and devices.

### BRIEF DESCRIPTION OF THE DRAWINGS

For a better understanding of the various described implementations, reference should be made to the Description of Implementations below, in conjunction with the following drawings in which like reference numerals refer to corresponding parts throughout the figures.

FIG. 1 is a representative smart home environment in accordance with some implementations.

FIG. 2 is a block diagram illustrating a representative network architecture that includes a smart home network in accordance with some implementations.

FIG. 3 illustrates a network-level view of an extensible platform for devices and services, which may be integrated with the smart home environment of FIG. 1 in accordance with some implementations.

FIG. 4 illustrates an abstracted functional view of the extensible platform of FIG. 3, with reference to a processing engine as well as devices of the smart home environment, in accordance with some implementations.

FIGS. 5A-5B are representative operating environments in which a video server system interacts with client devices and video sources, in accordance with some implementations.

FIG. 6 is a block diagram illustrating a representative video server system, in accordance with some implementations.

FIG. 7 is a block diagram illustrating a representative client device, in accordance with some implementations.

FIG. 8 is a block diagram illustrating a representative camera, in accordance with some implementations.

FIG. 9 is a block diagram illustrating a representative video server system and a corresponding data processing pipeline for captured image data, in accordance with some implementations.

FIGS. 10A-10K illustrate example user interfaces for facilitating review of captured image data and detected regions of interest, in accordance with some implementations.

FIG. 11 illustrates a flowchart representation of a method of providing image data for an identified region of interest, in accordance with some implementations.

Like reference numerals refer to corresponding parts throughout the several views of the drawings.

### DESCRIPTION OF IMPLEMENTATIONS

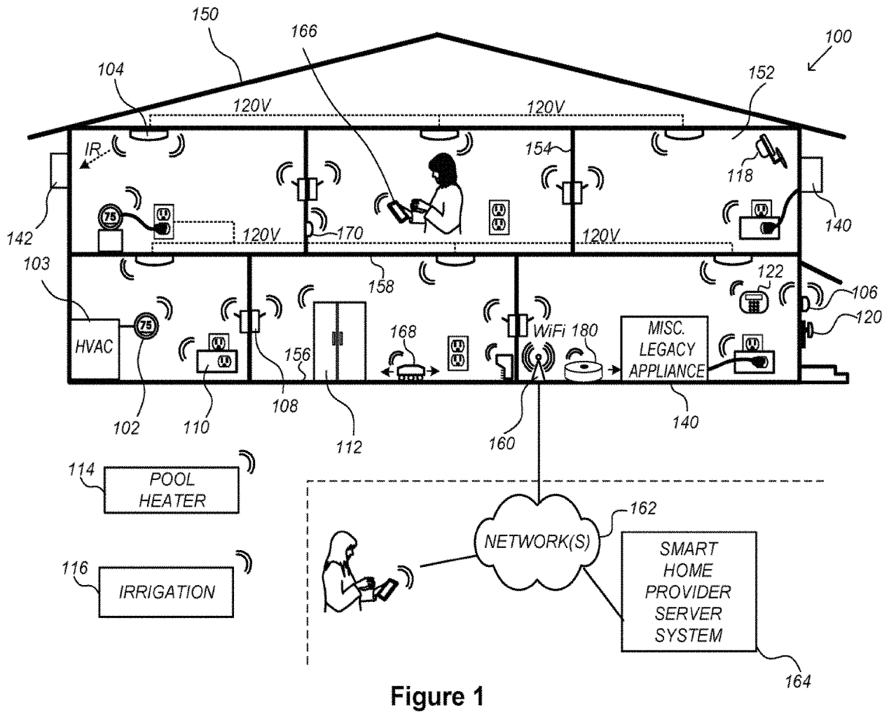

FIG. 1 is an example smart home environment 100 in accordance with some implementations. Smart home environment 100 includes a structure 150 (e.g., a house, office building, garage, or mobile home) with various integrated devices. It will be appreciated that devices may also be integrated into a smart home environment 100 that does not include an entire structure 150, such as an apartment, condominium, or office space. Further, the smart home environment 100 may control and/or be coupled to devices outside of the actual structure 150. Indeed, several devices in the smart home environment 100 need not be physically within the structure 150. For example, a device controlling a pool heater 114 or irrigation system 116 may be located outside of the structure 150.

The depicted structure 150 includes a plurality of rooms 152, separated at least partly from each other via walls 154. The walls 154 may include interior walls or exterior walls. Each room may further include a floor 156 and a ceiling 158. Devices may be mounted on, integrated with and/or supported by a wall 154, floor 156, or ceiling 158.

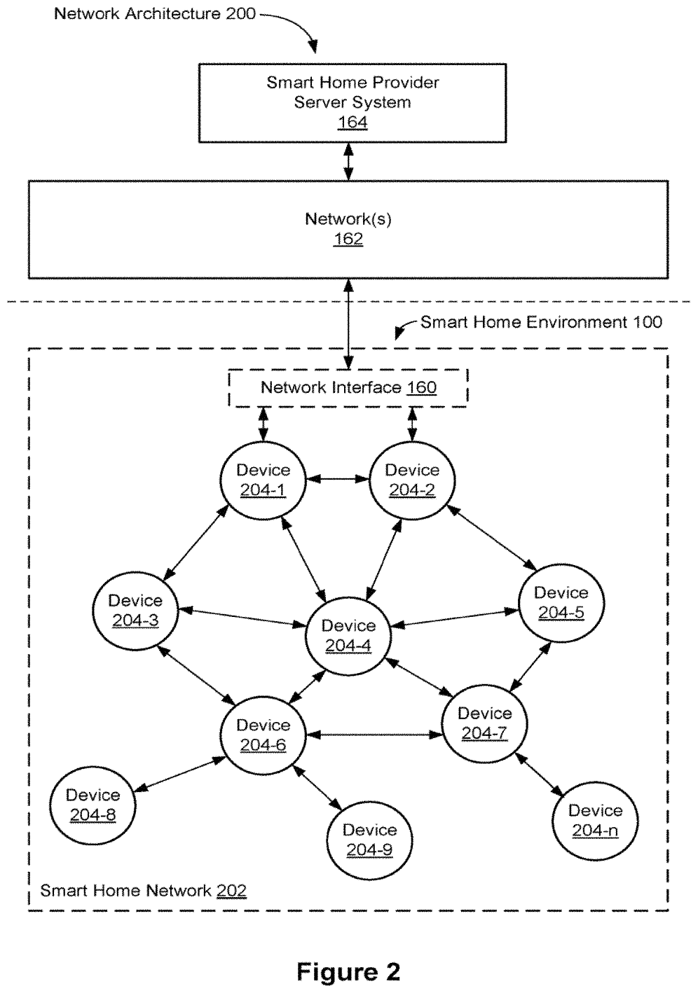

In some implementations, the integrated devices of the smart home environment 100 include intelligent, multi-sensing, network-connected devices that integrate seamlessly with each other in a smart home network (e.g., 202 FIG. 2) and/or with a central server or a cloud-computing system to provide a variety of useful smart home functions (collectively referred to as “smart devices”). The smart home environment 100 may include one or more smart devices, such as one or more intelligent, multi-sensing, network-connected: thermostats 102 (hereinafter referred to as “smart thermostats 102”), hazard detection units 104 (hereinafter referred to as “smart hazard detectors 104”), entryway interface devices 106 and 120 (hereinafter referred to as “smart doorbells 106” and “smart door locks 120”), alarm systems 122 (hereinafter referred to as “smart alarm systems 122”), wall switches 108 (hereinafter referred to as “smart wall switches 108”), wall plugs 110 (hereinafter referred to as “smart wall plugs 110”), appliances 112 (hereinafter referred to as “smart appliances 112”), cameras 118, and hub devices 180.

In some implementations, the one or more smart thermostats 102 detect ambient climate characteristics (e.g., temperature and/or humidity) and control an HVAC system 103 accordingly. For example, a respective smart thermostat 102 includes an ambient temperature sensor.

The one or more smart hazard detectors 104 may include thermal radiation sensors directed at respective heat sources (e.g., a stove, oven, other appliances, a fireplace, etc.). For example, a smart hazard detector 104 in a kitchen 153 includes a thermal radiation sensor directed at a stove/oven 112. A thermal radiation sensor may determine the temperature of the respective heat source (or a portion thereof) at which it is directed and may provide corresponding blackbody radiation data as output.

The smart doorbell 106 and/or the smart door lock 120 may detect a person's approach to or departure from a location (e.g., an outer door), control doorbell/door locking functionality (e.g., receive user inputs from a portable electronic device 166-1 to actuate bolt of the smart door lock 120), announce a person's approach or departure via audio or visual means, and/or control settings on a security system (e.g., to activate or deactivate the security system when occupants go and come).

The smart alarm system 122 may detect the presence of an individual within close proximity (e.g., using built-in IR sensors), sound an alarm (e.g., through a built-in speaker, or by sending commands to one or more external speakers), and send notifications to entities or users within/outside of the smart home network 100. In some implementations, the smart alarm system 122 also includes one or more input devices or sensors (e.g., keypad, biometric scanner, NFC transceiver, microphone) for verifying the identity of a user, and one or more output devices (e.g., display, speaker). In some implementations, the smart alarm system 122 may also be set to an “armed” mode, such that detection of a trigger condition or event causes the alarm to be sounded unless a disarming action is performed.

In some implementations, the smart home environment 100 includes one or more intelligent, multi-sensing, network-connected wall switches 108 (hereinafter referred to as “smart wall switches 108”), along with one or more intelligent, multi-sensing, network-connected wall plug interfaces 110 (hereinafter referred to as “smart wall plugs 110”). The smart wall switches 108 may detect ambient lighting conditions, detect room-occupancy states, and control a power and/or dim state of one or more lights. In some instances, smart wall switches 108 may also control a power state or speed of a fan, such as a ceiling fan. Smart wall plugs 110 control supply of power to one or more coupled devices. Smart wall plugs 110 control access to power based on sensor readings (e.g., power is not supplied to a coupled device if no users are present, based on a detected occupancy of a room) or remote control inputs (e.g., inputs received from a client device 504).

In some implementations, the smart home environment 100 of FIG. 1 includes a plurality of intelligent, multi-sensing, network-connected appliances 112 (hereinafter referred to as “smart appliances 112”), such as refrigerators, stoves, ovens, televisions, washers, dryers, lights, stereos, intercom systems, garage-door openers, floor fans, ceiling fans, wall air conditioners, pool heaters, irrigation systems, security systems, space heaters, window AC units, motorized duct vents, and so forth. In some implementations, when plugged in, an appliance may announce itself to the smart home network, such as by indicating what type of appliance it is, and it may automatically integrate with the controls of the smart home. Such communication by the appliance to the smart home may be facilitated by either a wired or wireless communication protocol. The smart home may also include a variety of non-communicating legacy appliances 140, such as old conventional washer/dryers, refrigerators, and the like, which may be controlled by smart wall plugs 110. The smart home environment 100 may further include a variety of partially communicating legacy appliances 142, such as infrared (“IR”) controlled wall air conditioners or other IR-controlled devices, which may be controlled by IR signals provided by the smart hazard detectors 104 or the smart wall switches 108.

In some implementations, the smart home environment 100 includes one or more network-connected cameras 118 that are configured to provide video monitoring and security in the smart home environment 100. The cameras 118 may be used to determine occupancy of the structure 150 and/or particular rooms 152 in the structure 150, and thus may act as occupancy sensors. For example, video captured by the cameras 118 may be processed to identify the presence of an occupant or an object in the structure 150 (e.g., in a particular room 152) or in the vicinity outside of the structure 150. Specific individuals or categories of individuals may be identified based, for example, on their appearance (e.g., height, face, clothing) and/or movement (e.g., their walk/gait). Specific objects or types of objects may be identified based, for example, on their appearance (e.g., shape, on-object text, on-object graphics). Cameras 118 may additionally include one or more sensors (e.g., IR sensors, motion detectors), input devices (e.g., microphone for capturing audio), and output devices (e.g., speaker for outputting audio).

The smart home environment 100 may additionally or alternatively include one or more devices having an occupancy sensor (e.g., the smart doorbell 106, smart door locks 120, touch screens, IR sensors, microphones, ambient light sensors, motion detectors, smart nightlights 170, etc.). In some implementations, the smart home environment 100 includes radio-frequency identification (RFID) readers (e.g., in each room 152 or a portion thereof) that determine occupancy based on RFID tags located on or embedded in occupants. For example, RFID readers may be integrated into the smart hazard detectors 104.

The smart home environment 100 may also include communication with devices outside of the physical home but within a proximate geographical range of the home. For example, the smart home environment 100 may include a pool heater monitor 114 that communicates a current pool temperature to other devices within the smart home environment 100 and/or receives commands for controlling the pool temperature. Similarly, the smart home environment 100 may include an irrigation monitor 116 that communicates information regarding irrigation systems within the smart home environment 100 and/or receives control information for controlling such irrigation systems.

By virtue of network connectivity, one or more of the smart home devices of FIG. 1 may further allow a user to interact with the device even if the user is not proximate to the device. For example, a user may communicate with a device using a computer (e.g., a desktop computer, laptop computer, or tablet) or other portable electronic device 166 (e.g., a mobile phone, such as a smart phone). A webpage or application may be configured to receive communications from the user and control the device based on the communications and/or to present information about the device's operation to the user. For example, the user may view a current set point temperature for a device (e.g., a stove) and adjust it using a computer. The user may be in the structure during this remote communication or outside the structure.

As discussed above, users may control smart devices in the smart home environment 100 using a network-connected computer or portable electronic device 166. In some examples, some or all of the occupants (e.g., individuals who live in the home) may register their device 166 with the smart home environment 100. Such registration may be made at a central server to authenticate the occupant and/or the device as being associated with the home and to give permission to the occupant to use the device to control the smart devices in the home. An occupant may use their registered device 166 to remotely control the smart devices of the home, such as when the occupant is at work or on vacation. The occupant may also use their registered device to control the smart devices when the occupant is actually located inside the home, such as when the occupant is sitting on a couch inside the home. It should be appreciated that instead of or in addition to registering devices 166, the smart home environment 100 may make inferences about which individuals live in the home and are therefore occupants and which devices 166 are associated with those individuals. As such, the smart home environment may “learn” who is an occupant and permit the devices 166 associated with those individuals to control the smart devices of the home.

In some implementations, in addition to containing processing and sensing capabilities, devices 102, 104, 106, 108, 110, 112, 114, 116, 118, 120, and/or 122 (collectively referred to as “the smart devices”) are capable of data communications and information sharing with other smart devices, a central server or cloud-computing system, and/or other devices that are network-connected. Data communications may be carried out using any of a variety of custom or standard wireless protocols (e.g., IEEE 802.15.4, Wi-Fi, ZigBee, 6LoWPAN, Thread, Z-Wave, Bluetooth Smart, I5A100.11a, WirelessHART, MiWi, etc.) and/or any of a variety of custom or standard wired protocols (e.g., Ethernet, HomePlug, etc.), or any other suitable communication protocol, including communication protocols not yet developed as of the filing date of this document.

In some implementations, data communications are conducted peer-to-peer (e.g., by establishing direct wireless communications channels between devices). In some implementations, the smart devices serve as wireless or wired repeaters. In some implementations, a first one of the smart devices communicates with a second one of the smart devices via a wireless router. The smart devices may further communicate with each other via a connection (e.g., network interface 160) to a network, such as the Internet 162. Through the Internet 162, the smart devices may communicate with a smart home provider server system 164 (also called a central server system and/or a cloud-computing system herein). In some implementations, the smart home provider server system 164 may include multiple server systems each dedicated to data processing associated with a respective subset of the smart devices (e.g., a video server system may be dedicated to data processing associated with camera(s) 118). The smart home provider server system 164 may be associated with a manufacturer, support entity, or service provider associated with the smart device(s). In some implementations, a user is able to contact customer support using a smart device itself rather than needing to use other communication means, such as a telephone or Internet-connected computer. In some implementations, software updates are automatically sent from the smart home provider server system 164 to smart devices (e.g., when available, when purchased, or at routine intervals).

In some implementations, the smart home environment 100 of FIG. 1 includes a hub device 180 that is communicatively coupled to the network(s) 162 directly or via the network interface 160. The hub device 180 is further communicatively coupled to one or more of the above intelligent, multi-sensing, network-connected devices (e.g., smart devices of the smart home environment 100). Each of these smart devices optionally communicates with the hub device 180 using one or more radio communication networks available at least in the smart home environment 100 (e.g., ZigBee, Z-Wave, Insteon, Bluetooth, Wi-Fi and other radio communication networks). In some implementations, the hub device 180 and devices coupled with/to the hub device can be controlled and/or interacted with via an application running on a smart phone, household controller, laptop, tablet computer, game console or similar electronic device. In some implementations, a user of such controller application can view status of the hub device or coupled smart devices, configure the hub device to interoperate with smart devices newly introduced to the home network, commission new smart devices, and adjust or view settings of connected smart devices, etc. In some implementations the hub device extends capabilities of low capability smart device to match capabilities of the highly capable smart devices of the same type, integrates functionality of multiple different device types—even across different communication protocols, and is configured to streamline adding of new devices and commissioning of the hub device.

FIG. 2 is a block diagram illustrating a representative network architecture 200 that includes a smart home network 202 in accordance with some implementations. In some implementations, one or more smart devices 204 in the smart home environment 100 (e.g., the devices 102, 104, 106, 108, 110, 112, 114, 116, 118, 180, and/or 122) combine to create a mesh network in the smart home network 202. In some implementations, the one or more smart devices 204 in the smart home network 202 operate as a smart home controller. In some implementations, a smart home controller has more computing power than other smart devices. In some implementations, a smart home controller processes inputs (e.g., from the smart device(s) 204, the electronic device 166, and/or the smart home provider server system 164) and sends commands (e.g., to the smart device(s) 204 in the smart home network 202) to control operation of the smart home environment 100. In some implementations, some of the smart device(s) 204 in the mesh network are “spokesman” nodes (e.g., node 204-1) and others are “low-powered” nodes (e.g., node 204-9). Some of the smart device(s) 204 in the smart home environment 100 are battery powered, while others have a regular and reliable power source, such as by connecting to wiring (e.g., to 120V line voltage wires) behind the walls 154 of the smart home environment. The smart devices that have a regular and reliable power source are referred to as “spokesman” nodes. These nodes are typically equipped with the capability of using a wireless protocol to facilitate bidirectional communication with a variety of other devices in the smart home environment 100, as well as with the central server or cloud-computing system 164. In some implementations, one or more “spokesman” nodes operate as a smart home controller. On the other hand, the devices that are battery powered are referred to as “low-power” nodes. These nodes tend to be smaller than spokesman nodes and typically only communicate using wireless protocols that require very little power, such as Zigbee, 6LoWPAN, etc.

In some implementations, some low-power nodes are incapable of bidirectional communication. These low-power nodes send messages, but they are unable to “listen.” Thus, other devices in the smart home environment 100, such as the spokesman nodes, cannot send information to these low-power nodes.

As described, the spokesman nodes and some of the low-powered nodes are capable of “listening.” Accordingly, users, other devices, and/or the central server or cloud-computing system 164 may communicate control commands to the low-powered nodes. For example, a user may use the portable electronic device 166 (e.g., a smartphone) to send commands over the Internet to the central server or cloud-computing system 164, which then relays the commands to one or more spokesman nodes in the smart home network 202. The spokesman nodes drop down to a low-power protocol to communicate the commands to the low-power nodes throughout the smart home network 202, as well as to other spokesman nodes that did not receive the commands directly from the central server or cloud-computing system 164.

In some implementations, a smart nightlight 170 is a low-power node. In addition to housing a light source, the smart nightlight 170 houses an occupancy sensor, such as an ultrasonic or passive IR sensor, and an ambient light sensor, such as a photo resistor or a single-pixel sensor that measures light in the room. In some implementations, the smart nightlight 170 is configured to activate the light source when its ambient light sensor detects that the room is dark and when its occupancy sensor detects that someone is in the room. In other implementations, the smart nightlight 170 is simply configured to activate the light source when its ambient light sensor detects that the room is dark. Further, in some implementations, the smart nightlight 170 includes a low-power wireless communication chip (e.g., a ZigBee chip) that regularly sends out messages regarding the occupancy of the room and the amount of light in the room, including instantaneous messages coincident with the occupancy sensor detecting the presence of a person in the room. As mentioned above, these messages may be sent wirelessly, using the mesh network, from node to node (i.e., smart device to smart device) within the smart home network 202 as well as over the one or more networks 162 to the central server or cloud-computing system 164.

Other examples of low-power nodes include battery-operated versions of the smart hazard detectors 104. These smart hazard detectors 104 are often located in an area without access to constant and reliable power and may include any number and type of sensors, such as smoke/fire/heat sensors, carbon monoxide/dioxide sensors, occupancy/motion sensors, ambient light sensors, temperature sensors, humidity sensors, and the like. Furthermore, the smart hazard detectors 104 may send messages that correspond to each of the respective sensors to the other devices and/or the central server or cloud-computing system 164, such as by using the mesh network as described above.

Examples of spokesman nodes include smart doorbells 106, smart thermostats 102, smart wall switches 108, and smart wall plugs 110. These devices 102, 106, 108, and 110 are often located near and connected to a reliable power source, and therefore may include more power-consuming components, such as one or more communication chips capable of bidirectional communication in a variety of protocols.

In some implementations, the smart home environment 100 includes service robots 168 that are configured to carry out, in an autonomous manner, any of a variety of household tasks.

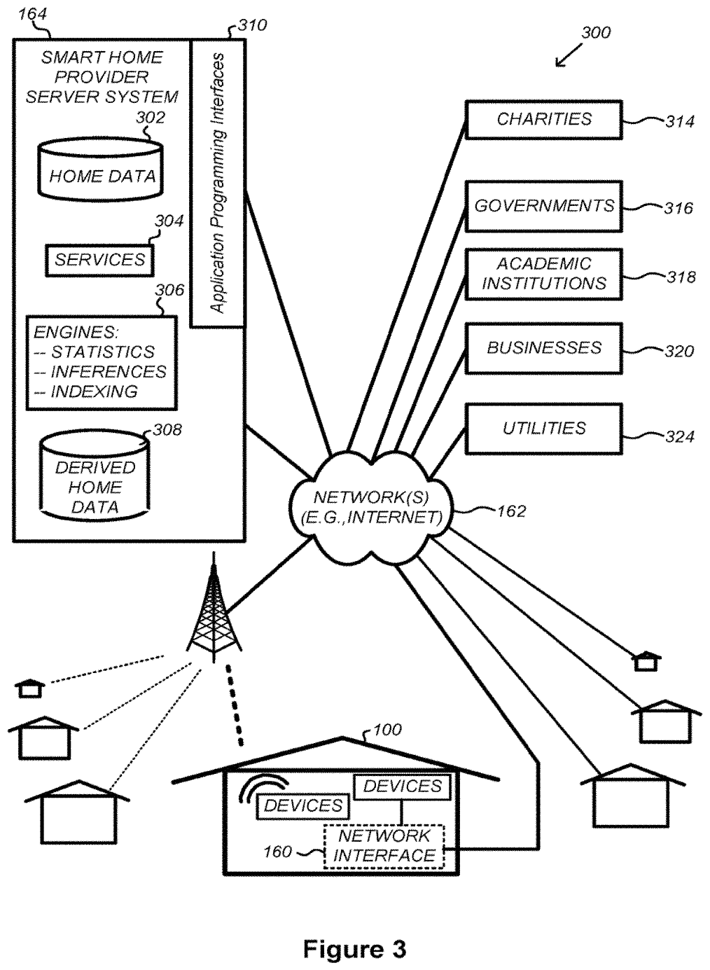

FIG. 3 illustrates a network-level view of an extensible devices and services platform 300 with which the smart home environment 100 of FIG. 1 is integrated, in accordance with some implementations. The extensible devices and services platform 300 include remote servers or cloud computing system 164. Each of the intelligent, network-connected devices (e.g., 102, 104, 106, 108, 110, 112, 114, 116, 118, etc.) from FIG. 1 (identified simply as “devices” in FIGS. 2-4) may communicate with the remote servers or cloud computing system 164. For example, a connection to the one or more networks 162 may be established either directly (e.g., using 3G/4G connectivity to a wireless carrier), or through a network interface 160 (e.g., a router, switch, gateway, hub, or an intelligent, dedicated whole-home control node), or through any combination thereof.

In some implementations, the devices and services platform 300 communicates with and collects data from the smart devices of the smart home environment 100. In addition, in some implementations, the devices and services platform 300 communicates with and collects data from a plurality of smart home environments across the world. For example, the smart home provider server system 164 collects home data 302 from the devices of one or more smart home environments, where the devices may routinely transmit home data or may transmit home data in specific instances (e.g., when a device queries the home data 302). Example collected home data 302 includes, without limitation, power consumption data, occupancy data, HVAC settings and usage data, carbon monoxide levels data, carbon dioxide levels data, volatile organic compounds levels data, sleeping schedule data, cooking schedule data, inside and outside temperature and humidity data, television viewership data, inside and outside noise level data, pressure data, video data, etc.

In some implementations, the smart home provider server system 164 provides one or more services 304 to smart homes. Example services 304 include, without limitation, software updates, customer support, sensor data collection/logging, remote access, remote or distributed control, and/or use suggestions (e.g., based on the collected home data 302) to improve performance, reduce utility cost, increase safety, etc. In some implementations, data associated with the services 304 is stored at the smart home provider server system 164, and the smart home provider server system 164 retrieves and transmits the data at appropriate times (e.g., at regular intervals, upon receiving a request from a user, etc.).

In some implementations, the extensible devices and the services platform 300 includes a processing engine 306, which may be concentrated at a single server or distributed among several different computing entities. In some implementations, the processing engine 306 includes engines configured to receive data from the devices of smart home environments (e.g., via the Internet and/or a network interface), to index the data, to analyze the data and/or to generate statistics based on the analysis or as part of the analysis. In some implementations, the analyzed data is stored as derived home data 308.

Results of the analysis or statistics may thereafter be transmitted back to the device that provided home data used to derive the results, to other devices, to a server providing a webpage to a user of the device, or to other non-smart device entities. In some implementations, use statistics, use statistics relative to use of other devices, use patterns, and/or statistics summarizing sensor readings are generated by the processing engine 306 and transmitted. The results or statistics may be provided via the one or more networks 162. In this manner, the processing engine 306 may be configured and programmed to derive a variety of useful information from the home data 302. A single server may include one or more processing engines.

The derived home data 308 may be used at different granularities for a variety of useful purposes, ranging from explicit programmed control of the devices on a per-home, per-neighborhood, or per-region basis (for example, demand-response programs for electrical utilities), to the generation of inferential abstractions that may assist on a per-home basis (for example, an inference may be drawn that the homeowner has left for vacation and so security detection equipment may be put on heightened sensitivity), to the generation of statistics and associated inferential abstractions that may be used for government or charitable purposes. For example, processing engine 306 may generate statistics about device usage across a population of devices and send the statistics to device users, service providers or other entities (e.g., entities that have requested the statistics and/or entities that have provided monetary compensation for the statistics).

In some implementations, to encourage innovation and research and to increase products and services available to users, the devices and services platform 300 exposes a range of application programming interfaces (APIs) 310 to third parties, such as charities 314, governmental entities 316 (e.g., the Food and Drug Administration or the Environmental Protection Agency), academic institutions 318 (e.g., university researchers), businesses 320 (e.g., providing device warranties or service to related equipment, targeting advertisements based on home data), utility companies 324, and other third parties. The APIs 310 are coupled to and permit third-party systems to communicate with the smart home provider server system 164, including the services 304, the processing engine 306, the home data 302, and the derived home data 308. In some implementations, the APIs 310 allow applications executed by the third parties to initiate specific data processing tasks that are executed by the smart home provider server system 164, as well as to receive dynamic updates to the home data 302 and the derived home data 308.

For example, third parties may develop programs and/or applications, such as web applications or mobile applications, that integrate with the smart home provider server system 164 to provide services and information to users. Such programs and applications may be, for example, designed to help users reduce energy consumption, to preemptively service faulty equipment, to prepare for high service demands, to track past service performance, etc., and/or to perform other beneficial functions or tasks.

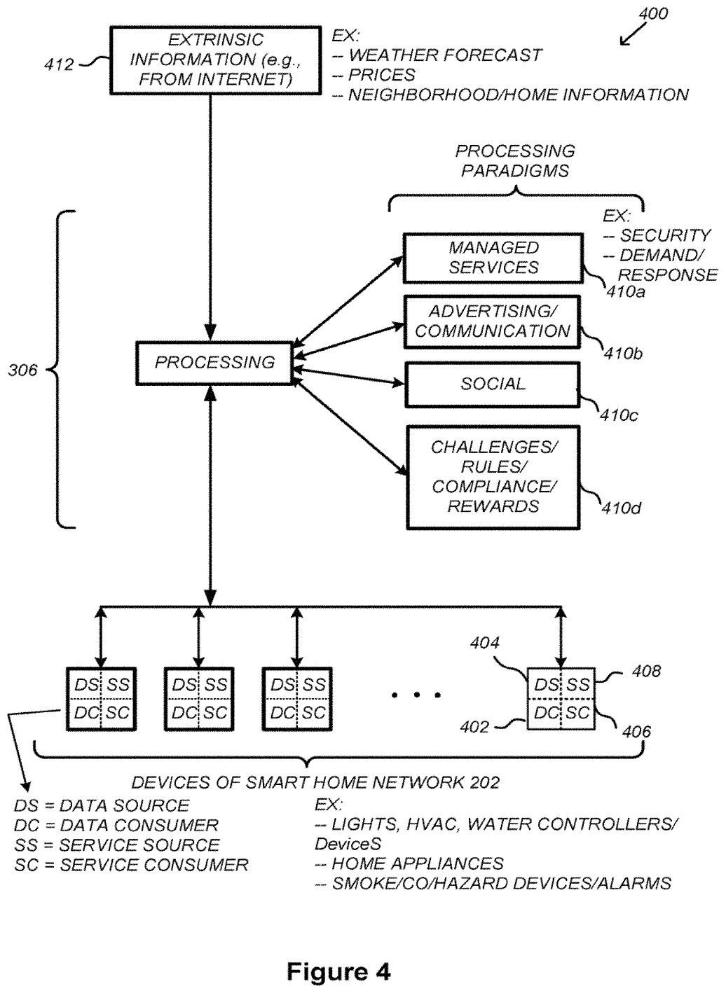

FIG. 4 illustrates an abstracted functional view 400 of the extensible devices and services platform 300 of FIG. 3, with reference to a processing engine 306 as well as devices of the smart home environment, in accordance with some implementations. Even though devices situated in smart home environments will have a wide variety of different individual capabilities and limitations, the devices may be thought of as sharing common characteristics in that each device is a data consumer 402 (DC), a data source 404 (DS), a services consumer 406 (SC), and a services source 408 (SS). Advantageously, in addition to providing control information used by the devices to achieve their local and immediate objectives, the extensible devices and services platform 300 may also be configured to use the large amount of data that is generated by these devices. In addition to enhancing or optimizing the actual operation of the devices themselves with respect to their immediate functions, the extensible devices and services platform 300 may be directed to “repurpose” that data in a variety of automated, extensible, flexible, and/or scalable ways to achieve a variety of useful objectives. These objectives may be predefined or adaptively identified based on, e.g., usage patterns, device efficiency, and/or user input (e.g., requesting specific functionality).

FIG. 4 shows the processing engine 306 as including a number of processing paradigms 410. In some implementations, the processing engine 306 includes a managed services paradigm 410a that monitors and manages primary or secondary device functions. The device functions may include ensuring proper operation of a device given user inputs, estimating that (e.g., and responding to an instance in which) an intruder is or is attempting to be in a dwelling, detecting a failure of equipment coupled to the device (e.g., a light bulb having burned out), implementing or otherwise responding to energy demand response events, and/or alerting a user of a current or predicted future event or characteristic. In some implementations, the processing engine 306 includes an advertising/communication paradigm 410b that estimates characteristics (e.g., demographic information), desires and/or products of interest of a user based on device usage. Services, promotions, products, or upgrades may then be offered or automatically provided to the user. In some implementations, the processing engine 306 includes a social paradigm 410c that uses information from a social network, provides information to a social network (for example, based on device usage), and/or processes data associated with user and/or device interactions with the social network platform. For example, a user's status as reported to trusted contacts on the social network may be updated to indicate when the user is home based on light detection, security system inactivation, or device usage detectors. As another example, a user may be able to share device-usage statistics with other users. In yet another example, a user may share HVAC settings that result in low power bills and other users may download the HVAC settings to their smart thermostat 102 to reduce their power bills.

In some implementations, the processing engine 306 includes a challenges/rules/compliance/rewards paradigm 410d that informs a user of challenges, competitions, rules, compliance regulations and/or rewards and/or that uses operation data to determine whether a challenge has been met, a rule or regulation has been complied with and/or a reward has been earned. The challenges, rules, and/or regulations may relate to efforts to conserve energy, to live safely (e.g., reducing exposure to toxins or carcinogens), to conserve money and/or equipment life, to improve health, etc. For example, one challenge may involve participants turning down their thermostat by one degree for one week. Those participants that successfully complete the challenge are rewarded, such as with coupons, virtual currency, status, etc. Regarding compliance, an example involves a rental-property owner making a rule that no renters are permitted to access certain owner's rooms. The devices in the room having occupancy sensors may send updates to the owner when the room is accessed.

In some implementations, the processing engine 306 integrates or otherwise uses extrinsic information 412 from extrinsic sources to improve the functioning of one or more processing paradigms. The extrinsic information 412 may be used to interpret data received from a device, to determine a characteristic of the environment near the device (e.g., outside a structure that the device is enclosed in), to determine services or products available to the user, to identify a social network or social-network information, to determine contact information of entities (e.g., public-service entities such as an emergency-response team, the police or a hospital) near the device, to identify statistical or environmental conditions, trends or other information associated with a home or neighborhood, and so forth.

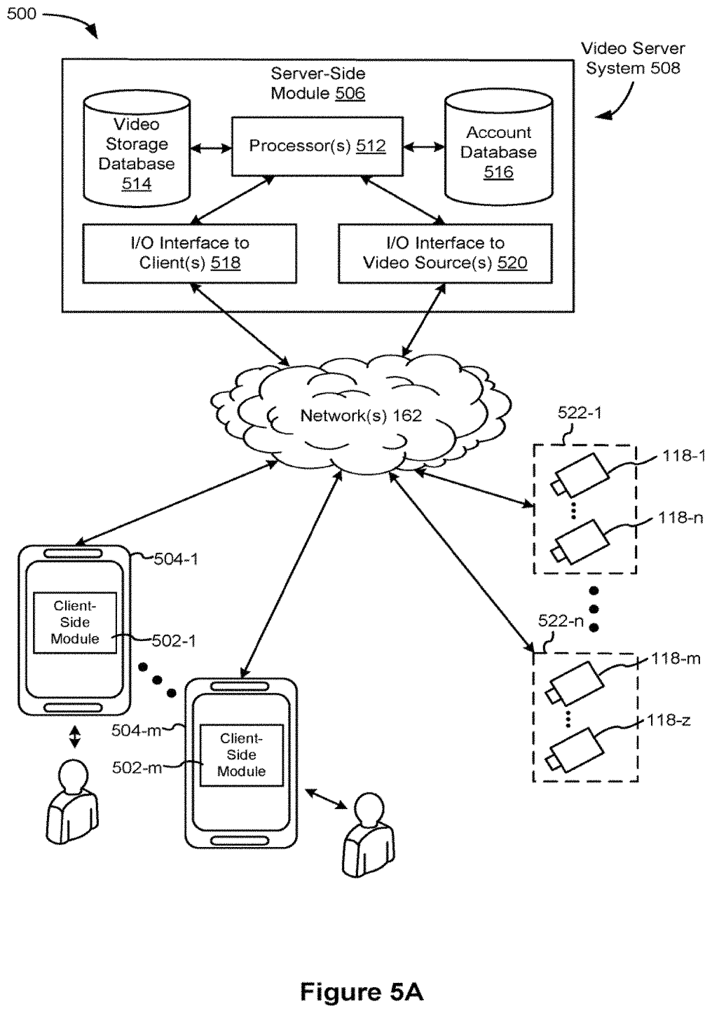

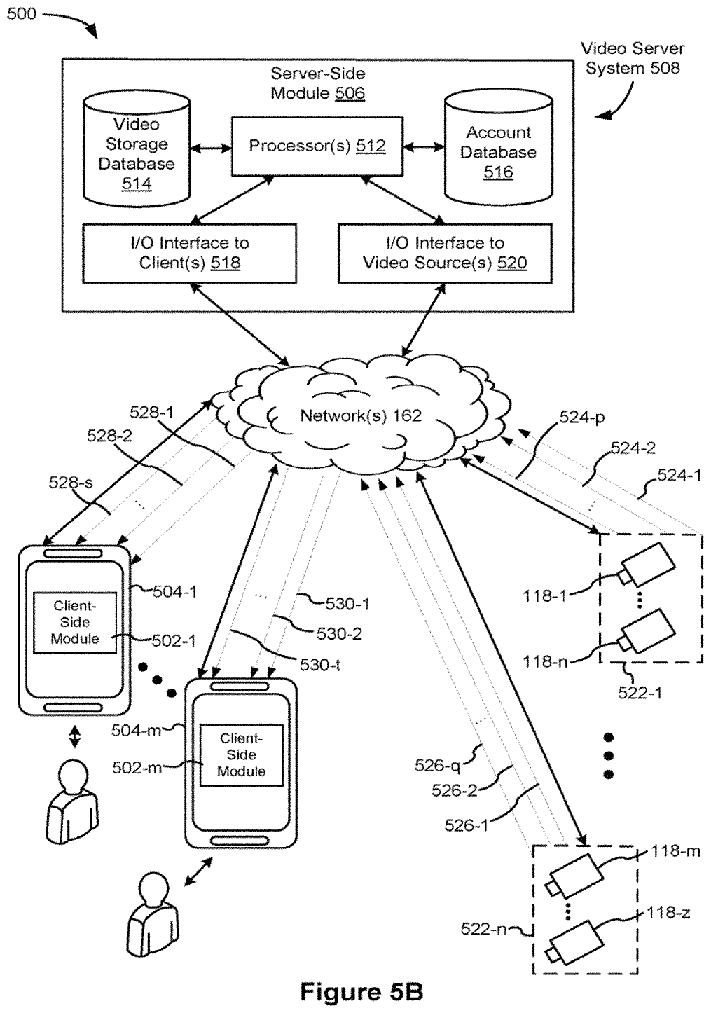

FIG. 5A illustrates a representative operating environment 500 in which a video server system 508 provides data processing for monitoring and facilitating review of motion events in video streams captured by video cameras 118. As shown in FIG. 5A, the video server system 508 receives video data from video sources 522 (including cameras 118) located at various physical locations (e.g., inside homes, restaurants, stores, streets, parking lots, and/or the smart home environments 100 of FIG. 1). Each video source 522 may be bound to one or more reviewer accounts, and the video server system 508 provides video monitoring data for the video source 522 to client devices 504 associated with the reviewer accounts. For example, the portable electronic device 166 is an example of the client device 504.

In some implementations, the smart home provider server system 164 or a component thereof serves as the video server system 508. In some implementations, the video server system 508 is a dedicated video processing server that provides video processing services to video sources and client devices 504 independent of other services provided by the video server system 508.

In some implementations, each of the video sources 522 includes one or more video cameras 118 that capture video and send the captured video to the video server system 508 substantially in real-time. In some implementations, each of the video sources 522 includes a controller device (not shown) that serves as an intermediary between the one or more cameras 118 and the video server system 508. The controller device receives the video data from the one or more cameras 118, optionally performs some preliminary processing on the video data, and sends the video data to the video server system 508 on behalf of the one or more cameras 118 substantially in real-time. In some implementations, each camera has its own on-board processing capabilities to perform some preliminary processing on the captured video data before sending the processed video data (along with metadata obtained through the preliminary processing) to the controller device and/or the video server system 508.

As shown in FIG. 5A, in accordance with some implementations, each of the client devices 504 includes a client-side module 502. The client-side module 502 communicates with a server-side module 506 executed on the video server system 508 through the one or more networks 162. The client-side module 502 provides client-side functionality for the event monitoring and review processing and communications with the server-side module 506. The server-side module 506 provides server-side functionality for event monitoring and review processing for any number of client-side modules 502 each residing on a respective client device 504. The server-side module 506 also provides server-side functionality for video processing and camera control for any number of the video sources 522, including any number of control devices and the cameras 118.

In some implementations, the server-side module 506 includes one or more processors 512, a video storage database 514, an account database 516, an I/O interface to one or more client devices 518, and an I/O interface to one or more video sources 520. The I/O interface to one or more clients 518 facilitates the client-facing input and output processing for the server-side module 506. The account database 516 stores a plurality of profiles for reviewer accounts registered with the video processing server, where a respective user profile includes account credentials for a respective reviewer account, and one or more video sources linked to the respective reviewer account. The I/O interface to one or more video sources 520 facilitates communications with one or more video sources 522 (e.g., groups of one or more cameras 118 and associated controller devices). The video storage database 514 stores raw video data received from the video sources 522, as well as various types of metadata, such as motion events, event categories, event category models, event filters, and event masks, for use in data processing for event monitoring and review for each reviewer account.

Examples of a representative client device 504 include a handheld computer, a wearable computing device, a personal digital assistant (PDA), a tablet computer, a laptop computer, a desktop computer, a cellular telephone, a smart phone, an enhanced general packet radio service (EGPRS) mobile phone, a media player, a navigation device, a game console, a television, a remote control, a point-of-sale (POS) terminal, a vehicle-mounted computer, an e-book reader, or a combination of any two or more of these data processing devices or other data processing devices.

Examples of the one or more networks 162 include local area networks (LAN) and wide area networks (WAN) such as the Internet. The one or more networks 162 are implemented using any known network protocol, including various wired or wireless protocols, such as Ethernet, Universal Serial Bus (USB), FIREWIRE, Long Term Evolution (LTE), Global System for Mobile Communications (GSM), Enhanced Data GSM Environment (EDGE), code division multiple access (CDMA), time division multiple access (TDMA), Bluetooth, Wi-Fi, voice over Internet Protocol (VoIP), Wi-MAX, or any other suitable communication protocol.

In some implementations, the video server system 508 is implemented on one or more standalone data processing apparatuses or a distributed network of computers. In some implementations, the video server system 508 also employs various virtual devices and/or services of third party service providers (e.g., third-party cloud service providers) to provide the underlying computing resources and/or infrastructure resources of the video server system 508. In some implementations, the video server system 508 includes, but is not limited to, a server computer, a handheld computer, a tablet computer, a laptop computer, a desktop computer, or a combination of any two or more of these data processing devices or other data processing devices. In some implementations, the video server system 508 and the smart home provider server system 164 are implemented as a single system, which may be configured to perform any combination of features or functionalities described with respect to the two systems throughout.

The server-client environment 500 shown in FIG. 5A includes both a client-side portion (e.g., the client-side module 502) and a server-side portion (e.g., the server-side module 506). The division of functionality between the client and server portions of operating environment 500 can vary in different implementations. Similarly, the division of functionality between a video source 522 and the video server system 508 can vary in different implementations. For example, in some implementations, the client-side module 502 is a thin-client that provides only user-facing input and output processing functions, and delegates all other data processing functionality to a backend server (e.g., the video server system 508). Similarly, in some implementations, a respective one of the video sources 522 is a simple video capturing device that continuously captures and streams video data to the video server system 508 with limited or no local preliminary processing on the video data. Although many aspects of the present technology are described from the perspective of the video server system 508, the corresponding actions performed by a client device 504 and/or the video sources 522 would be apparent to one of skill in the art. Similarly, some aspects of the present technology may be described from the perspective of a client device or a video source, and the corresponding actions performed by the video server would be apparent to one of skill in the art. Furthermore, some aspects of the present technology may be performed by the video server system 508, a client device 504, and a video source 522 cooperatively.

In some implementations, a video source 522 (e.g., a camera 118) transmits one or more streams of video data to the video server system 508. In some implementations, the one or more streams may include multiple streams, of respective resolutions and/or frame rates, of the raw video captured by the camera 118. In some implementations, the multiple streams may include a “primary” stream with a certain resolution and frame rate, corresponding to the raw video captured by the camera 118, and one or more additional streams. An additional stream may be the same video stream as the “primary” stream but at a different resolution and/or frame rate, or a stream that captures a portion of the “primary” stream (e.g., cropped to include a portion of the field of view or pixels of the primary stream) at the same or different resolution and/or frame rate as the “primary” stream.

In some implementations, the video server system 508 transmits one or more streams of video data to a client device 504 to facilitate event monitoring by a user. In some implementations, the one or more streams may include multiple streams, of respective resolutions and/or frame rates, of the same video feed. In some implementations, the multiple streams may include a “primary” stream with a certain resolution and frame rate, corresponding to the video feed, and one or more additional streams. An additional stream may be the same video stream as the “primary” stream but at a different resolution and/or frame rate, or a stream that shows a portion of the “primary” stream (e.g., cropped to include portion of the field of view or pixels of the primary stream) at the same or different resolution and/or frame rate as the “primary” stream.

FIG. 5B illustrates the same operating environment 500 as FIG. 5A, but with the multiple streams transmitted from video sources 522 to video server system 508 and the multiple streams transmitted from video server system 508 to client devices 504 shown. In FIG. 5B, video sources 522 transmit multiple streams to the video server system 508 through networks 162. For example, video source 522-1 transmits streams 524-1, 524-2, thru 524-p of video data to the video server system 508. Video source 522-n transmits 526-1, 526-2, thru 526-q of video data to the video server system 508. The video server system 508 transmits multiple streams of video data to client devices 504. For example, video server system 508 transmits streams 528-1, 528-2, thru 528-s of video data to client device 504-1. Video server system 508 transmits streams 530-1, 530-2, thru 530-t of video data to client device 504-m.

In some implementations, the image sensors on the camera 118 are capable of capturing raw video and images at a certain resolution, and the image or video streams transmitted from the camera 118 to the video server system 508 are transmitted at a same or lower resolution than the capture resolution. For example, camera 118 may be capable of capturing 4K-resolution raw video, and the video streams transmitted to the video server system 508 are 1080p resolution or lower video encoded from the 4K raw video. The raw 4K video may be stored at the camera 118 (e.g., in a cache, in a buffer, in volatile or non-volatile memory) for later retrieval.

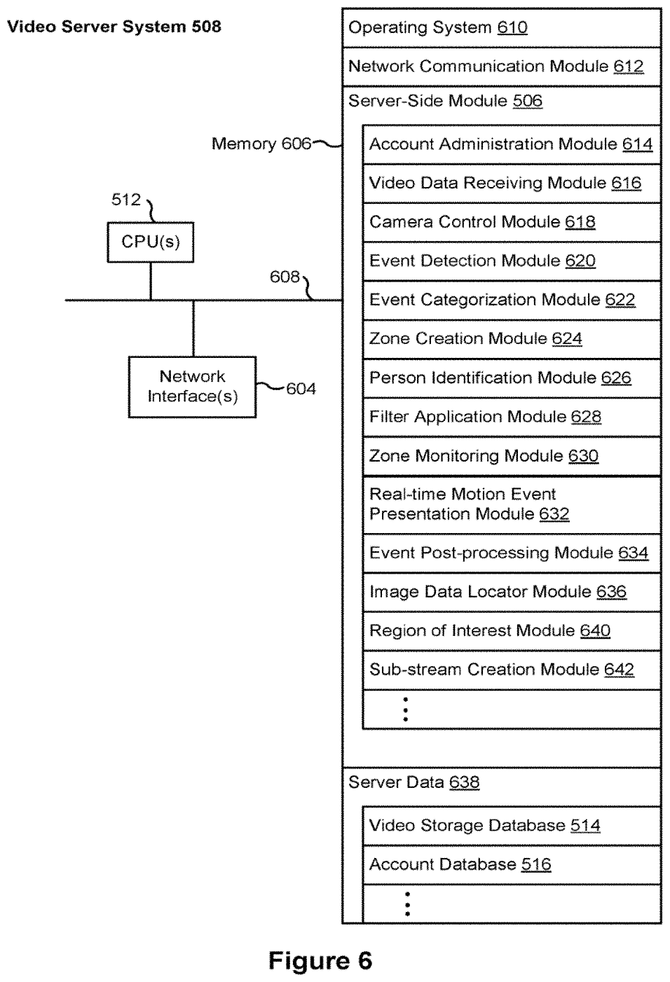

FIG. 6 is a block diagram illustrating the video server system 508 in accordance with some implementations. The video server system 508, typically, includes one or more processing units (CPUs) 512, one or more network interfaces 604 (e.g., including the I/O interface to one or more clients 518 and the I/O interface to one or more video sources 520), memory 606, and one or more communication buses 608 for interconnecting these components (sometimes called a chipset). The memory 606 includes high-speed random access memory, such as DRAM, SRAM, DDR RAM, or other random access solid state memory devices; and, optionally, includes non-volatile memory, such as one or more magnetic disk storage devices, one or more optical disk storage devices, one or more flash memory devices, or one or more other non-volatile solid state storage devices. The memory 606, optionally, includes one or more storage devices remotely located from the one or more processing units 512. The memory 606, or alternatively the non-volatile memory within the memory 606, includes a non-transitory computer-readable storage medium. In some implementations, the memory 606, or the non-transitory computer-readable storage medium of the memory 606, stores the following programs, modules, and data structures, or a subset or superset thereof:

Operating system 610 including procedures for handling various basic system services and for performing hardware dependent tasks;

Network communication module 612 for connecting the video server system 508 to other computing devices (e.g., the client devices 504 and the video sources 522 including camera(s) 118) connected to the one or more networks 162 via the one or more network interfaces 604 (wired or wireless);

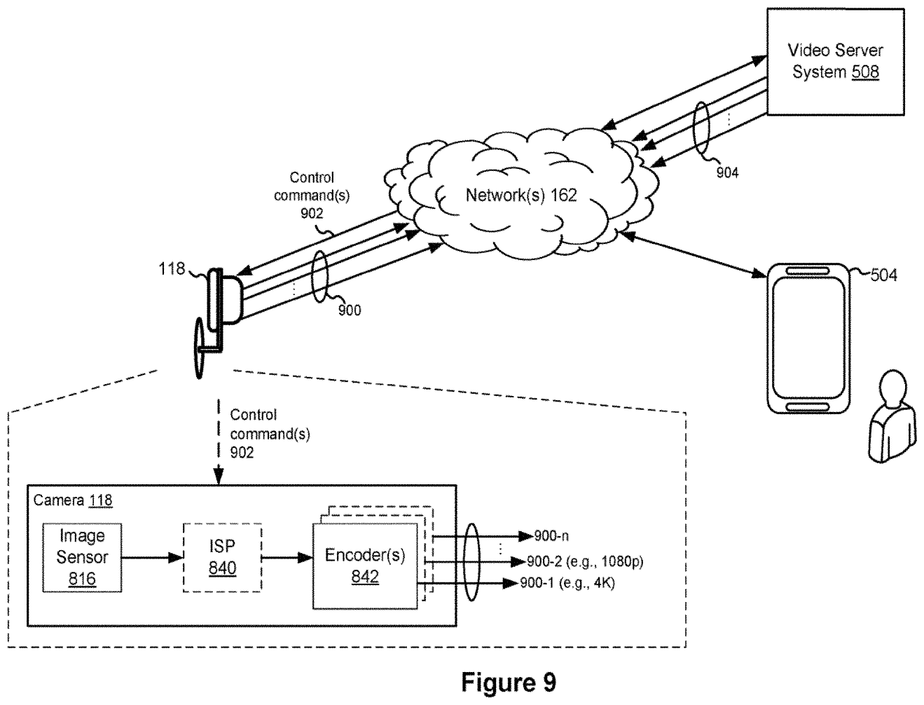

Server-side module 506, which provides server-side data processing and functionalities for the event monitoring and review, including but not limited to:
Account administration module 614 for creating reviewer accounts, performing camera registration processing to establish associations between video sources to their respective reviewer accounts, and providing account login-services to the client devices 504;
Video data receiving module 616 for receiving raw/processed image data (e.g., streams 900 having various resolutions, frame rates, encoding characteristics, etc., FIG. 9) from the video sources 522, and preparing the received video data for event processing and long-term storage in the video storage database 514;
Camera control module 618 for generating and sending server-initiated control commands to modify the operation modes of the video sources, and/or receiving and forwarding user-initiated control commands to modify the operation modes of the video sources 522;
Event detection module 620 for detecting motion event candidates in video streams from each of the video sources 522, including motion track identification, false positive suppression, and event mask generation and caching;
Event categorization module 622 for categorizing motion events detected in received video streams;
Zone creation module 624 for generating zones of interest in accordance with user input;
Person identification module 626 for identifying characteristics associated with presence of humans in the received video streams;
Filter application module 628 for selecting event filters (e.g., event categories, zones of interest, a human filter, etc.) and applying the selected event filter to past and new motion events detected in the video streams;
Zone monitoring module 630 for monitoring motions within selected zones of interest and generating notifications for new motion events detected within the selected zones of interest, where the zone monitoring takes into account changes in surrounding context of the zones and is not confined within the selected zones of interest;
Real-time motion event presentation module 632 for dynamically changing characteristics of event indicators displayed in user interfaces as new event filters, such as new event categories or new zones of interest, are created, and for providing real-time notifications as new motion events are detected in the video streams;
Event post-processing module 634 for providing summary time-lapse for past motion events detected in video streams, and providing event and category editing functions to user for revising past event categorization results;
Image data locator module 636 for locating image data for selected regions of interest (e.g., locating high-resolution images/frames from video streams 900, FIG. 9);
Region of interest module 640 for identifying regions of interest based on user selection and/or detected motion activity, events, and elements (e.g., persons, faces, objects); and
Sub-stream creation module 642 for creating additional streams (e.g., sub-streams, second and additional streams) of video data;

server data 638 storing data for use in data processing for motion event monitoring and review, including but not limited to:
Video storage database 514 storing raw/processed image data (e.g., streams 900 having various resolutions, frame rates, encoding characteristics, etc., FIG. 9) associated with each of the video sources 522 (each including one or more cameras 118) of each reviewer account, as well as event categorization models (e.g., event clusters, categorization criteria, etc.), event categorization results (e.g., recognized event categories, and assignment of past motion events to the recognized event categories, representative events for each recognized event category, etc.), event masks for past motion events, video segments for each past motion event, preview video (e.g., sprites) of past motion events, and other relevant metadata (e.g., names of event categories, location of the cameras 118, creation time, duration, DTPZ settings of the cameras 118, etc.) associated with the motion events; and
Account database 516 for storing account information for reviewer accounts, including login-credentials, associated video sources, relevant user and hardware characteristics (e.g., service tier, camera model, storage capacity, processing capabilities, etc.), user interface settings, monitoring preferences, etc.

Each of the above-identified elements may be stored in one or more of the previously mentioned memory devices and corresponds to a set of instructions for performing a function described above. The above identified modules or programs (i.e., sets of instructions) need not be implemented as separate software programs, procedures, or modules, and thus various subsets of these modules may be combined or otherwise re-arranged in various implementations. In some implementations, the memory 606, optionally, stores a subset of the modules and data structures identified above. Furthermore, the memory 606, optionally, stores additional modules and data structures not described above.

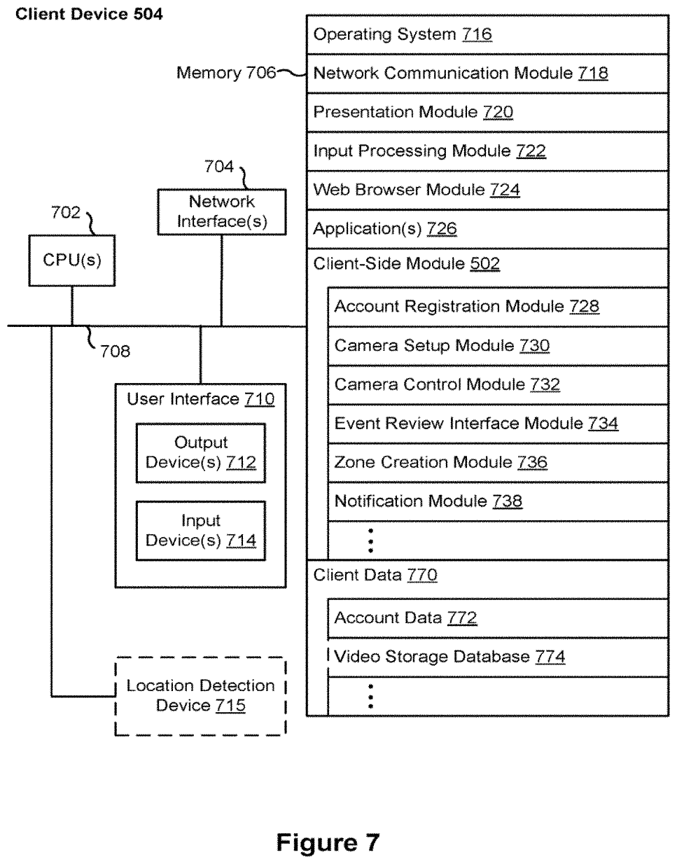

FIG. 7 is a block diagram illustrating a representative client device 504 associated with a reviewer account in accordance with some implementations. The client device 504, typically, includes one or more processing units (CPUs) 702, one or more network interfaces 704, memory 706, and one or more communication buses 708 for interconnecting these components (sometimes called a chipset). The client device 504 also includes a user interface 710. The user interface 710 includes one or more output devices 712 (e.g., one or more speakers and/or one or more visual displays). The user interface 710 also includes one or more input devices 714, including user interface components that facilitate user input (e.g., a keyboard, a mouse, a voice-command input unit or microphone, a touch screen display, a touch-sensitive input pad, a gesture capturing camera, and/or other input buttons or controls). In some implementations, the client device 504 optionally uses a microphone and voice recognition or a camera and gesture recognition to supplement or replace the keyboard and/or the mouse. In some implementations, the client device 504 includes one or more cameras, scanners, or photo sensor units for capturing images. In some implementations, the client device 504 optionally includes a location detection device 715, such as a GPS (global positioning satellite) or other geo-location receiver, for determining the location of the client device 504.

The memory 706 includes high-speed random access memory, such as DRAM, SRAM, DDR RAM, or other random access solid state memory devices; and, optionally, includes non-volatile memory, such as one or more magnetic disk storage devices, one or more optical disk storage devices, one or more flash memory devices, or one or more other non-volatile solid state storage devices. The memory 706, optionally, includes one or more storage devices remotely located from the one or more processing units 702. The memory 706, or alternatively the non-volatile memory within the memory 706, includes a non-transitory computer-readable storage medium. In some implementations, the memory 706, or the non-transitory computer-readable storage medium of memory 706, stores the following programs, modules, and data structures, or a subset or superset thereof:

Operating system 716 including procedures for handling various basic system services and for performing hardware dependent tasks;

Network communication module 718 for connecting the client device 504 to other computing devices (e.g., the video server system 508 and the video sources 522) connected to the one or more networks 162 via the one or more network interfaces 704 (wired or wireless);

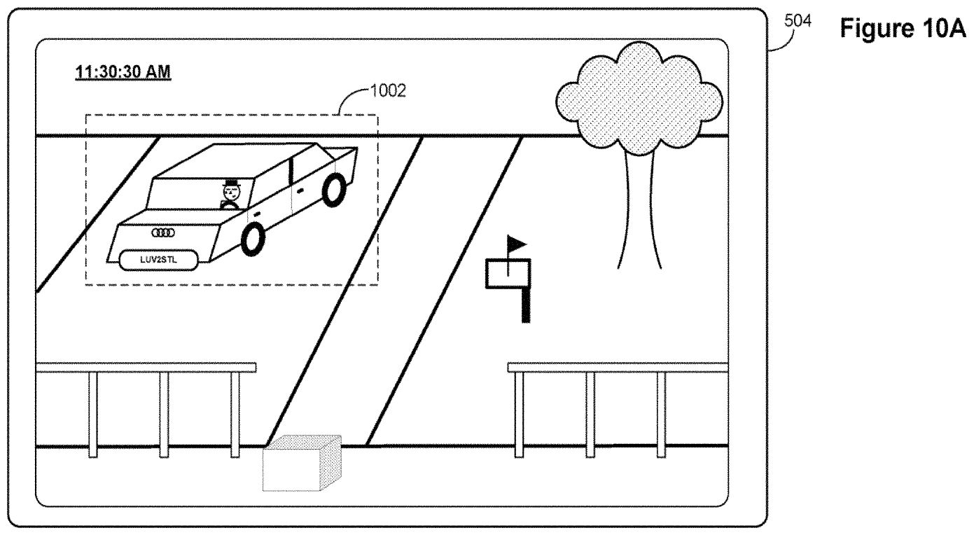

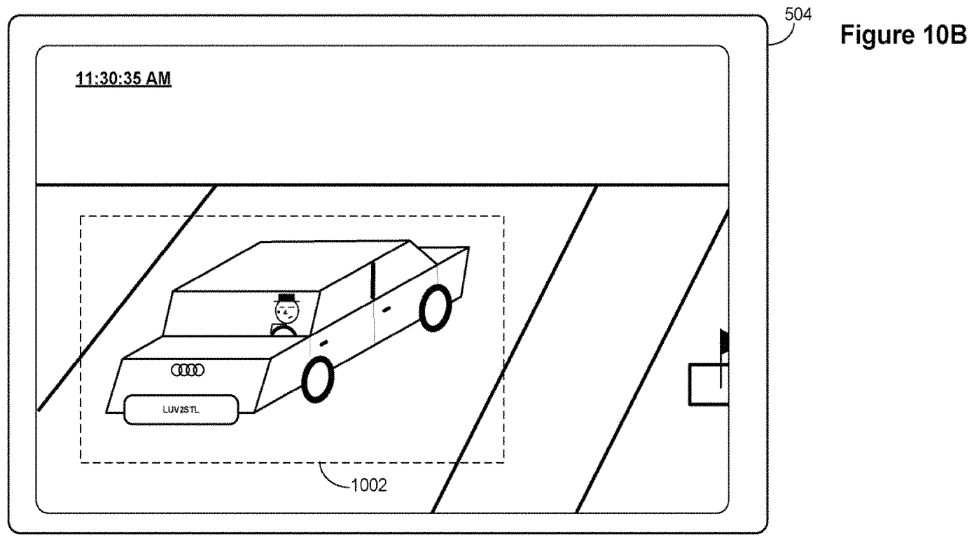

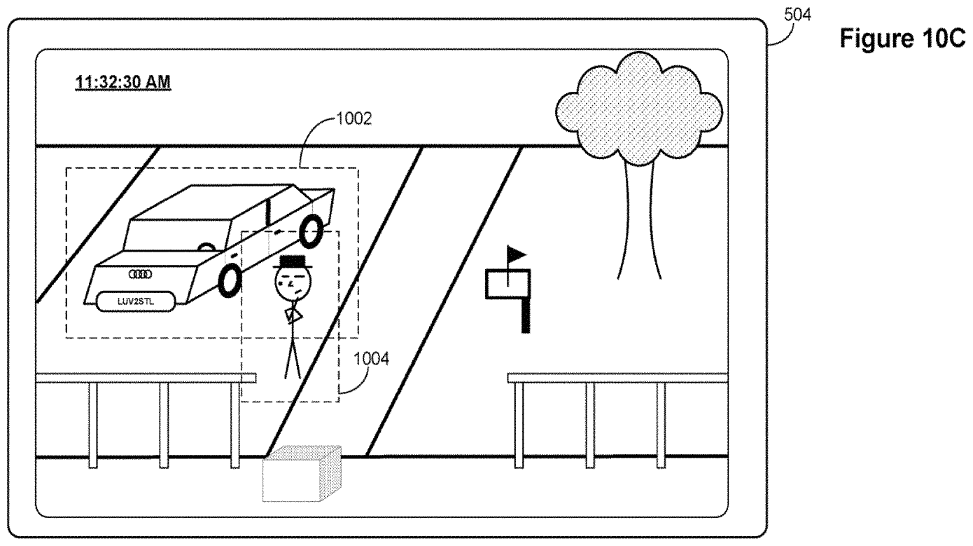

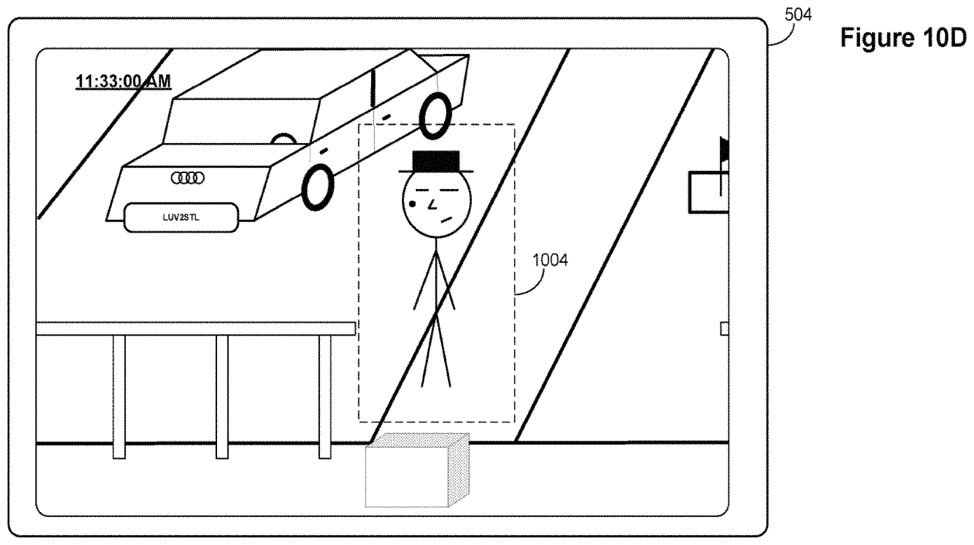

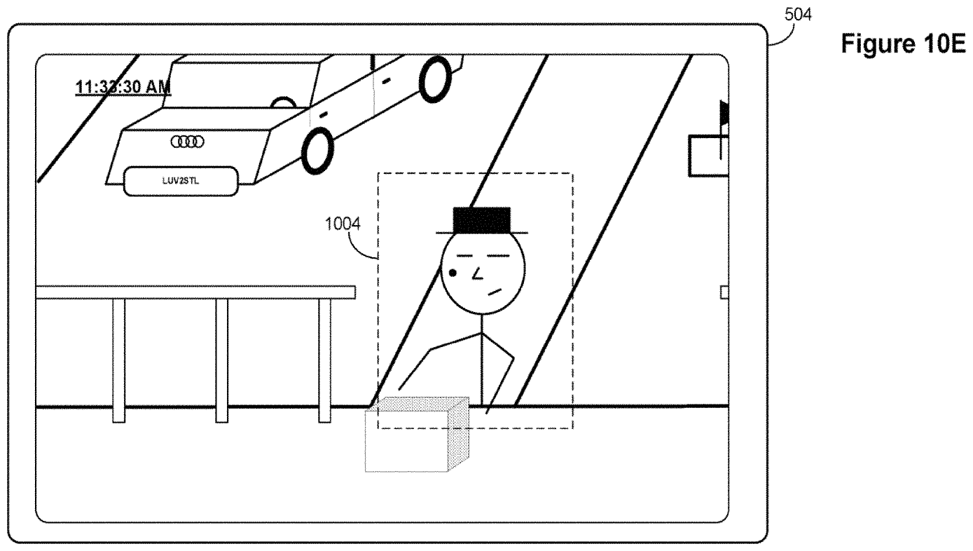

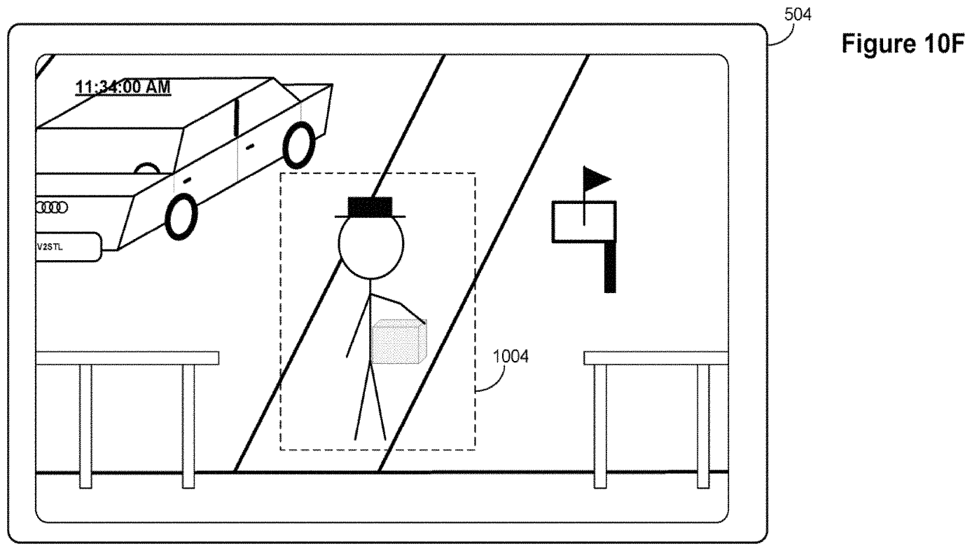

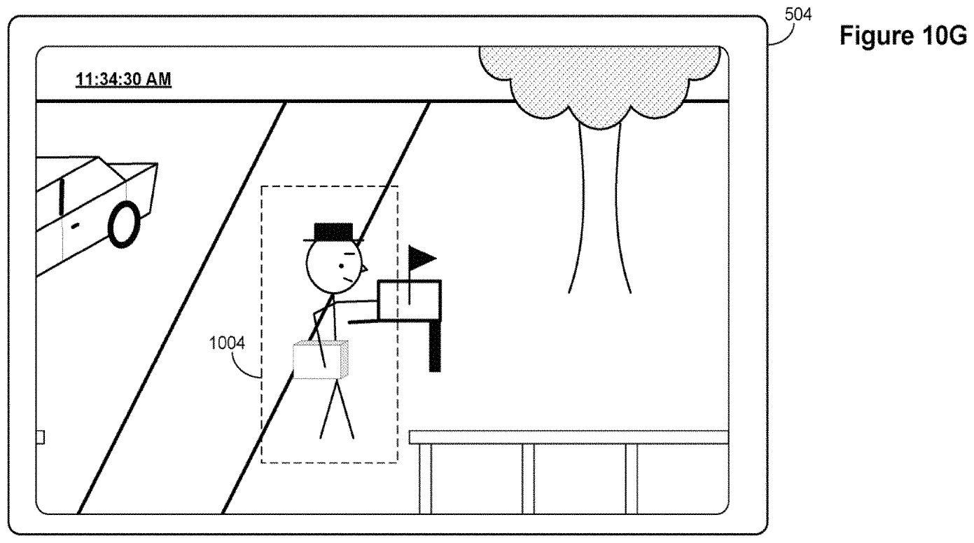

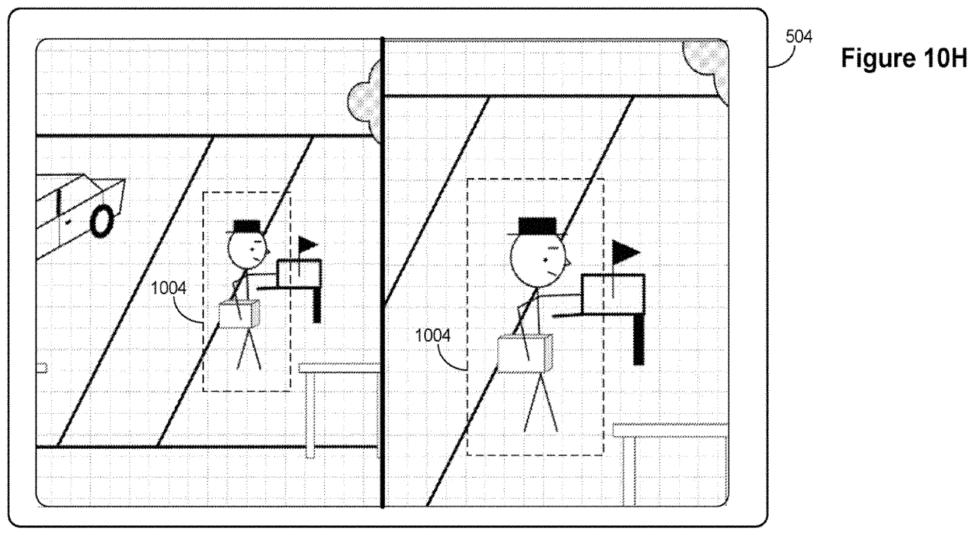

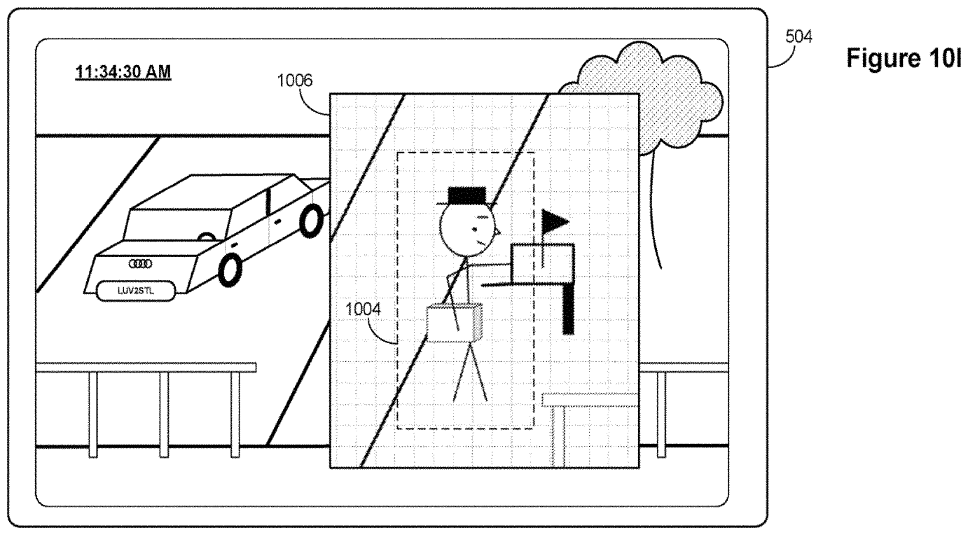

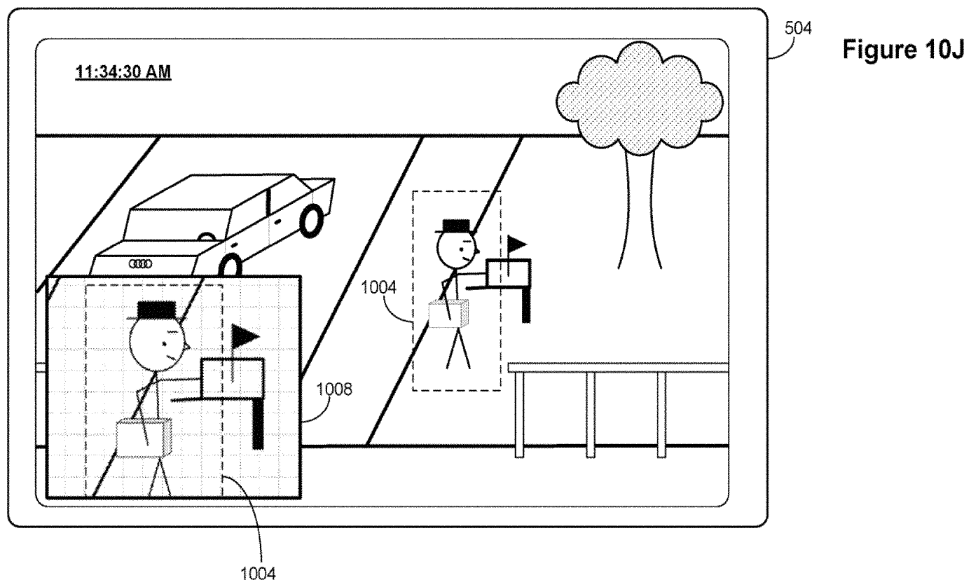

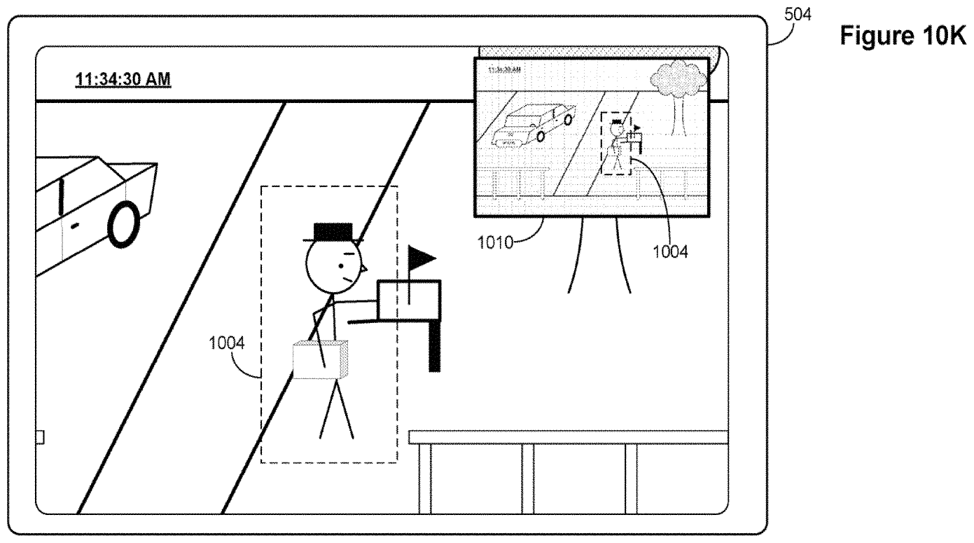

Presentation module 720 for enabling presentation of information (e.g., user interfaces for application(s) 726 or the client-side module 502, widgets, websites and web pages thereof, and/or games, audio and/or video content, text, etc.) at the client device 504 via the one or more output devices 712 (e.g., displays, speakers, etc.) associated with the user interface 710 (e.g., user interfaces of FIGS. 10A-10E);

Input processing module 722 for detecting one or more user inputs or interactions from one of the one or more input devices 714 and interpreting the detected input or interaction;

Web browser module 724 for navigating, requesting (e.g., via HTTP), and displaying websites and web pages thereof, including a web interface for logging into a reviewer account, controlling the video sources associated with the reviewer account, establishing and selecting event filters, and editing and reviewing motion events detected in the video streams of the video sources;

One or more applications 726 for execution by the client device 504 (e.g., games, social network applications, smart home applications, and/or other web or non-web based applications);

Client-side module 502, which provides client-side data processing and functionalities for monitoring and reviewing motion events detected in the video streams of one or more video sources, including but not limited to:
Account registration module 728 for establishing a reviewer account and registering one or more video sources with the video server system 508;
Camera setup module 730 for setting up one or more video sources within a local area network, and enabling the one or more video sources to access the video server system 508 on the Internet through the local area network;
Camera control module 732 for generating control commands for modifying an operating mode of the one or more video sources in accordance with user input;
Event review interface module 734 for providing user interfaces for selecting/defining regions of interest (e.g., region of interest I 006, FIG. 1 OB), reviewing event timelines, editing event categorization results, selecting event filters, presenting real-time filtered motion events based on existing and newly created event filters (e.g., event categories, zones of interest, a human filter, etc.), presenting real-time notifications (e.g., pop-ups) for newly detected motion events, and presenting smart time-lapse of selected motion events;
Zone creation module 736 for providing a user interface for creating zones of interest for each video stream in accordance with user input, and sending the definitions of the zones of interest to the video server system 508; and
Notification module 738 for generating real-time notifications for all or selected motion events on the client device 504 outside of the event review user interface; and

client data 770 storing data associated with the reviewer account and the video sources 522, including, but is not limited to:
Account data 772 storing information related with the reviewer account, and the video sources, such as cached login credentials, camera characteristics, user interface settings, display preferences, etc.; and
(optional) Video storage database 774 for storing raw/processed image data (e.g., streams 900 having various resolutions, frame rates, encoding characteristics, etc., FIG. 9) associated with each of the video sources 522 (each including one or more cameras 118) of each reviewer account.

Each of the above identified elements may be stored in one or more of the previously mentioned memory devices and corresponds to a set of instructions for performing a function described above. The above identified modules or programs (i.e., sets of instructions) need not be implemented as separate software programs, procedures, modules, or data structures, and thus various subsets of these modules may be combined or otherwise re-arranged in various implementations. In some implementations, memory 706, optionally, stores a subset of the modules and data structures identified above. Furthermore, the memory 706, optionally, stores additional modules and data structures not described above.

In some implementations, at least some of the functions of the video server system 508 are performed by the client device 504, and the corresponding sub-modules of these functions may be located within the client device 504 rather than the video server system 508. In some implementations, at least some of the functions of the client device 504 are performed by the video server system 508, and the corresponding sub-modules of these functions may be located within the video server system 508 rather than the client device 504. The client device 504 and the video server system 508 shown in FIGS. 6-7, respectively, are merely illustrative, and different configurations of the modules for implementing the functions described herein are possible in various implementations.

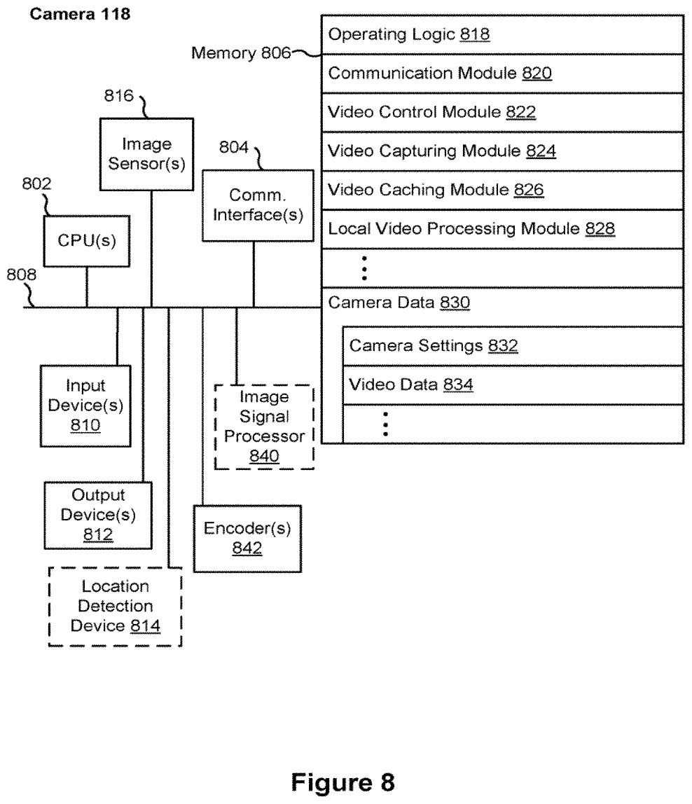

FIG. 8 is a block diagram illustrating a representative video camera 118 in accordance with some implementations. In some implementations, the camera 118 includes one or more processing units (e.g., CPUs, ASICs, FPGAs, microprocessors, and the like) 802, one or more communication interfaces 804, memory 806, and one or more communication buses 808 for interconnecting these components (sometimes called a chip set). The camera 118 includes one or more image sensors 816 (e.g., an array of pixel sensors) for capturing raw image data. In some implementations, the camera 118 includes one or more input devices 810 (e.g., one or more buttons for receiving input, and/or one or more microphones). In some implementations, the camera 118 includes one or more output devices 812 (e.g., one or more indicator lights, a sound card, a speaker, and/or a small display for displaying textual information and error codes). In some implementations, the camera 118 optionally includes a location detection device 814, such as a GPS (global positioning satellite) or other geo-location receiver, for determining the location of the camera 118.

In some implementations, the camera 118 includes an optional image signal processor (ISP) 840 configured to perform operations on the raw image data to modify characteristics of the captured image data (e.g., enhancing image quality). In some implementations, the camera 118 includes one or more encoders 842 configured to compress/encode raw or processed image data (e.g., raw image data captured by the image sensor 816, optionally processed image data output by the ISP 840, etc.). Both the ISP 840 and the encoders 842 are described in greater detail with respect to FIG. 9.

The memory 806 includes high-speed random access memory, such as DRAM, SRAM, DDR RAM, or other random access solid state memory devices; and, optionally, includes non-volatile memory, such as one or more magnetic disk storage devices, one or more optical disk storage devices, one or more flash memory devices, or one or more other non-volatile solid state storage devices. The memory 806, or alternatively the non-volatile memory within the memory 806, includes a non-transitory computer-readable storage medium. In some implementations, the memory 806, or the non-transitory computer-readable storage medium of the memory 806, stores the following programs, modules, and data structures, or a subset or superset thereof:

Operating system 818 including procedures for handling various basic system services and for performing hardware dependent tasks;

Network communication module 820 for connecting the camera 118 to other computing devices (e.g., the video server system 508, the client device 504, network routing devices, one or more controller devices, and networked storage devices) connected to the one or more networks 162 via the one or more communication interfaces 804 (wired or wireless);

Video control module 822 for modifying the operation mode (e.g., zoom level, cropping, resolution, frame rate, recording and playback volume, lighting adjustment, AE and IR modes, etc.) of the camera 118, enabling/disabling the audio and/or video recording functions of the camera 118, changing the pan and tilt angles of the camera 118, resetting the camera 118, and/or the like;

Video capturing module 824 for capturing and generating video stream(s) (e.g., image sensor 816 capturing raw image data, encoders 842 generating streams 900 having various resolutions, frame rates, fields of view, encoding characteristics, etc., FIG. 9) and sending the video stream(s) to the video server system 508 as a continuous feed, in short bursts, or on a frame-by-frame basis;

Video caching module 826 for storing some or all captured video data locally at one or more local storage devices (e.g., memory, flash drives, internal hard disks, portable disks, etc.);

Local video processing module 828 for performing preliminary processing of the captured video data locally at the camera 118 (e.g., operations by the ISP 840, encoders 842, etc.), including for example, compressing and encrypting the captured video data for network transmission, image recognition (e.g., facial recognition), preliminary motion event detection, preliminary false positive suppression for motion event detection, preliminary motion vector generation, etc.; and

Camera data 830 storing data, including but not limited to:
Camera settings 832, including network settings, camera operation settings, camera storage settings, etc.; and
Video data 834, including raw and/or processed image data (e.g., raw image data, image data for streams 900 having various resolutions, frame rates, encoding characteristics, etc., FIG. 9) associated with each of the video sources 522 (each including one or more cameras 118) and/or motion vectors for detected motion event candidates to be sent to the video server system 508.

Each of the above identified elements may be stored in one or more of the previously mentioned memory devices and corresponds to a set of instructions for performing a function described above. The above identified modules or programs (i.e., sets of instructions) need not be implemented as separate software programs, procedures, or modules, and thus various subsets of these modules may be combined or otherwise re-arranged in various implementations. In some implementations, the memory 806, optionally, stores a subset of the modules and data structures identified above. Furthermore, memory 806, optionally, stores additional modules and data structures not described above.

In some implementations, the functions of any of the devices and systems described herein (e.g., video server system 508, client device 504, camera 118, etc.) are interchangeable with one another and may be performed by any other devices or systems, where the corresponding sub-modules of these functions may additionally and/or alternatively be located within and executed by any of the devices and systems. For example, functions performed by the image data locator module 636 of the video server system 508 (e.g., locating image data for selected regions of interest) may be performed additionally and/or alternatively by the camera 118 (e.g., with respect to image data stored in the video storage database 514, camera data 830, etc.). The devices and systems shown in and described with respect to FIGS. 6-8 are merely illustrative, and different configurations of the modules for implementing the functions described herein are possible in various implementations.

FIG. 9 illustrates a representative video server system and a corresponding data processing pipeline for captured image data, in accordance with some implementations. A video camera 118 (in addition to one or more other optional image/video capture devices in the same or a different device environment) captures image data of a scene using the image sensor 816. Captured image data is then processed by one or more encoders 842 (and optionally by the image signal processor (ISP) 840) to generate one or more processed data streams 900 (e.g., 900-1, 900-2, . . . 900-n; 524-1 thru 524-p and/or 526-1 thru 526-q, FIG. 5B). The generated data stream(s) 900 may then be transmitted to the video server system 508 for further processing (e.g., motion detection, event processing, etc.), storage, and/or distribution to devices for display. Any methods or processes described with respect to FIG. 9 may be performed additionally and/or alternatively to the implementations described with respect to the operating environment of FIGS. 5A-5B.

Camera 118 (e.g., image sensor 816) captures unprocessed image data (i.e., raw image data) (e.g., image data has not been enhanced, not compressed/encoded in accordance with any encoding parameters, etc.). In some implementations, the camera 118 continuously captures raw image data substantially in real-time.

An optional image signal processor (ISP) 840 (or one or more modules thereof, not shown) performs one or more operations on the raw image data to modify characteristics of the captured image data (e.g., enhancing image quality). Examples of such operations include, but are not limited to: automatic exposure functions for providing capture of illuminance/color ranges by the image sensor 816; noise reduction techniques for improving signal-to-noise ratio (SNR); color processing techniques (e.g., white balance, color correction, gamma correction, or color conversion, etc.); and/or other image enhancement operations.

One or more encoders 842 employ coding techniques for compressing/encoding image data (e.g., the raw image data captured by the image sensor 816, the optionally processed image data output by the ISP 840, etc.). In some implementations, the encoder(s) 842 are used to convert, encode, or compress image data (e.g., raw or processed) into one or more image/video streams 900 (or image/video sub-streams) having respective pluralities of images or video frames. Each of the images/frames of the streams 900 have respective timestamps indicating times at which the images/frames were captured. While some streams 900 are video streams comprising successive frames of video, other streams 900 may comprise streams of images that are not successive frames of a video (e.g., images selectively captured in accordance with a predefined or variable frequency, in response to control commands where motion has been detected by video server system 508, etc.).

In some implementations, encoder(s) 842 are configured to generate one or more streams 900 having different image resolutions (e.g., 4K, 1080p, 720p, etc.) and frame rates (e.g., 30 frames per second). The encoder(s) 842 may also be configured to perform one or more operations for manipulating image characteristics of raw or processed image data (e.g., operations for scaling display resolution of image data, modifying aspect ratio, cropping/re-sizing field of view, etc.). In some implementations, the encoder(s) 842 are configured to encode raw or processed image data in accordance with one or more encoding parameters (e.g., defined by any variety of coding standards, such as MPEG, H.264, JPEG, etc.). In some implementations, the size of data for images/frames having a higher image resolution is larger than the size of data for images/frames having a smaller image resolution. In some implementations, the one or more streams 900 are distinct with respect to image resolution, frame rate, and/or other image/encoding characteristics (e.g., video sub-stream 900-2 has a framerate of 60 frames per second and images encoded at a 1080p resolution, while video sub-stream 900-1 has a framerate of 1 frame per second and images encoded at a 4K resolution). In some implementations, at least some of the one or more streams 900 have a lower image resolution than the raw image data captured by image sensor 816 (e.g., the raw image data has a 4K resolution, and at least one stream 900 has a resolution lower than 4K).

In some implementations, any of the image data described above (e.g., raw image data, processed image data generated by any modules such as the ISP 840, encoders 842, etc.) is transmitted by the camera 118 to a remote device/system (e.g., video server system 508, client device 504, etc.) for storage and/or streaming to a remote client device. Additionally and/or alternatively, any of the image data described above is stored locally on the camera 118 (e.g., video data 834, FIG. 8) for subsequent streaming to a client device (e.g., client device 504) either directly or via a video server system (e.g., video server system 508).

The one or more streams 900 may be generated according to the implementations above by a single encoder (e.g., one encoder that outputs multiple streams/sub-streams of image/video data corresponding to different resolutions, frame rates, and/or other image/encoding characteristics). Alternatively, multiple encoders may be configured to generate respective streams/sub-streams based on the raw (or processed) image data (e.g., each encoder generates a stream having a respective resolution, frame rate, and/or other image/encoding characteristics).

In some implementations, one or more operations of the camera 118 are performed in accordance with control commands 902. For example, in some implementations, commencing or ceasing capture of image data by the image sensor 816 is performed in response to control commands 902 (e.g., generation of a stream 900 is initiated in response to detected motion in the scene). In some implementations, streams 900 are generated in accordance with received control commands 902 that specify one or more parameters (e.g., stream resolution, stream frame rate, encoding parameters, instructions for manipulating/modifying raw or processed image data, etc.). Control commands 902 may be generated locally (e.g., at the camera 118) or received from one or more devices or systems (e.g., received from video server system 508, client device 504, etc.).

While some streams 900 may be continuously transmitted to devices or systems (e.g., to video server system 508, which is then provided to client device 504 for review, etc.), other streams 900 (or frames/images of the streams) may be transmitted in accordance with a predefined or variable frequency (e.g., transmit frame(s) once every minute). In some implementations, streams 900 (or frames/images of the streams) are transmitted in response to receiving one or more control commands 902 (e.g., video server system 508 provides a control command 902 to camera 118 in response to detecting motion in the scene, and a frame of stream 900 is transmitted to video server system 508 in response to receiving the control command). In some implementations, one or more streams 900 may be transmitted in response to one or more events occurring in or near the field of view of the camera 118 and detected by the camera 118. For example, one or more streams 900 may be communicated in response to the camera 118 detecting an audio event, (such as any noise, or a particular learned noise such as a baby crying, a vehicle driving, an audible alarm, siren, a door closing/opening, a window breaking, etc.), detecting a visual event (such as any movement, or a particular movement or object such as an unrecognized person, a known person, a known type of person such as a mailperson, an animal, a vehicle, a particular type of vehicle or branded vehicle, etc.), or detecting a particular combination of an audible and visual event (such as any movement together with the sound of a siren).

In some implementations, the video server system 508 performs data processing for event monitoring and motion detection on one or more streams 900 received from the camera 118. Additionally and/or alternatively, event monitoring and motion detection are performed locally at the camera 118.

In some implementations, the video server system 508 may transmit one or more streams 904 (e.g., 528-1 thru 528-s or 530-1 thru 530-t, FIG. 5B) to a client device 504. The one or more streams 904 are generated in accordance with the data processing performed by the video server system 508 on the one or more streams 900. In some implementations, the streams 904 include a first stream or sub-stream (e.g., a primary stream) that shows the full field of view of the scene captured by camera 118 (e.g., uncropped video scaled to fit the display area), and a second stream or sub-stream that shows a portion of the field of view (e.g., cropping the field of view to a relevant portion). In some implementations, the second stream tracks a region of interest in the video by showing a portion of the field of view that includes a region of interest, and the portion of the field of view that is shown may change as the region of interest moves within the field of view (e.g., the region of interest corresponds to motion activity detected in the video). The second stream may have a higher scale level than the first stream, such that the portion of the field of view that includes the region of interest is in-focus. The second stream may have a higher resolution than the first stream, such that details of the shown portion of the field of view are more apparent. In some implementations, the multiple streams (e.g., a 30 fps (frames per second) 1080p stream of the entire field of view as well as a 1 fps 4 k stream of the entire field of view) may be communicated to the video server system which subsequently crops one or more of the streams. In other implementations, one or more cropped versions may be communicated from the camera to the video server system (e.g., a 30 fps 1080p stream of the entire field of view as well as a 30 fps 4 k stream of a cropped portion of the field of view). The particular coordinates used for cropping the image may be determined by the camera 118 based, e.g., on motion/audio/event detection at the camera 118, or may be determined by the video server system 508 based, e.g., on motion/audio event detection at the camera 118 and/or video server system 508 and subsequently communicated as control command(s) 902 to the camera 118. In this context, audio detection refers to using one or more microphones on the camera 118 or other devices associated with the camera 118 to detect a direction/location of a sound source and use such detected direction/location to define an event zone.

Although not shown, in some implementations, the camera 118 (or the components thereof, such as the ISP 840, encoders 842, etc.) may include one or more additional modules for performing additional operations on raw or processed image data. Furthermore, operations performed by any of the modules or components described above may be performed by one or more separate modules not shown.

Attention is now directed towards implementations of user interfaces and associated processes that may be implemented on a respective client device 504. The client device may have one or more speakers enabled to output sound, one or more input devices (e.g., microphone, mouse, keyboard, touch-sensitive surface) enabled to receive inputs (e.g., sound inputs, contact inputs, keystrokes, mouse movements and clicks), and a display screen enabled to display information (e.g., media content, webpages and/or user interfaces for an application). FIGS. 10A-10K illustrate example user interfaces for facilitating review of captured image data in accordance with some implementations.

In some implementations, inputs may be made on a touch screen (where the touch-sensitive surface and the display are combined) on the device. In some implementations, the device detects inputs on a touch-sensitive surface that is separate from the display. In some implementations, the touch sensitive surface has a primary axis that corresponds to a primary axis on the display. In accordance with these implementations, the device detects contacts with the touch-sensitive surface at locations that correspond to respective locations on the display. In this way, user inputs detected by the device on the touch-sensitive surface are used by the device to manipulate the user interface on the display of the device when the touch-sensitive surface is separate from the display. It should be understood that similar methods are, optionally, used for other user interfaces described herein.

In some implementations, the device receives and responds to finger inputs (e.g., finger contacts, finger tap gestures, finger swipe gestures, etc.). It should be understood that, in some implementations, one or more of the finger inputs may be replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

Referring to FIG. 10A, playback of video streams/sub-streams is presented on the client device 504 (e.g., streams 904 are generated and transmitted to client device 504 for display, FIG. 9). In this example, a first video stream comprising images of a scene (e.g., the field of view of camera 118) is played on the client device 504. In FIG. 10A, the example scene is a front area of a house. Multiple elements are present in this scene, such as a porch, a package left on the porch, a mailbox, a driveway, and an unknown car coming into the driveway. In some implementations, the first video stream has a first image resolution and a first frame rate (e.g., a default resolution of 1080p image resolution, a frame rate of 60 frames per second). In some implementations, the first video stream is scaled to fit its display area.

A region of interest in the field of view may be identified by the video server system 508 and/or camera 118. The region of interest may be identified based on detected motion activity, events, and/or elements in the field of view. Elements may include, for example, persons, faces, pets, and/or objects. In FIG. 10A, a region of interest 1002 corresponding to an unknown car entering the field of view (e.g., the unknown car coming into the driveway) is identified. Optionally, the boundaries and/or the area of the region of interest may be displayed to the user (e.g., the boundaries are displayed on client device 504, the area within the boundaries is shaded).

In some implementations, from frame to frame, the region of interest may shift within the field of view along with the motion activity and/or element(s) to which the region of interest corresponds; the position of the region of interest tracks the motion activity of the corresponding element.

In some implementations, in accordance with identification of a region of interest in the field of view, a second video stream comprising images of a portion of the field of view may be played on the client device 504 concurrently with (e.g., side-by-side, picture-in-picture, overlay) or in lieu of the first video stream. The second video stream shows a portion of the field of view that includes the region of interest. In some implementations, the field of view is cropped by the video server system 508 to the portion shown in the second video stream. In some implementations, the portion of the field of view that is shown in the second video stream may pan, tilt, and/or zoom in order to follow the region of interest.

In some implementations, the second video stream is generated by the video server system 508. The video server system 508 receives streams 900 from the camera 118, processes the streams 900 to detect motion activity, events, and elements, and identify one or more regions of interest based on the detected motion activity, events, and elements. The video server system 508 identifies the portion of the field of view that includes the region of interest, and extracts from the streams 900 image data corresponding to the portion of the field of view or requests from the camera 118 raw image sensor data corresponding to the portion of the field of view (e.g., image data or image sensor data for the pixels corresponding to the portion of the field of view). The server system 508 encodes the second stream from the extracted image data or requested image sensor data. In some implementations, the second stream has a higher resolution than the first video stream. In some implementations, the second stream has the same resolution as the first video stream. In some implementations, the second stream appears to the user to be zoomed-in compared to the first stream.

For example, raw video may be captured at 4K resolution. A first stream is generated from the 4K raw video at 1080p resolution. For the second stream, video data corresponding to the portion that includes identified region of interest is extracted from the 4K raw video, and 1080p-resolution video is encoded from the extracted video data.

Referring to FIG. 10B, a second video stream is being played on client device 504 in lieu of the first video stream. The field of view is cropped in the second stream to a portion that includes the region of interest 1002, and the cropped portion appears as if scaled up compared to the first stream. In some implementations, the second video stream is cropped at the extraction stage or the encoding/generation stage. For example, extracting pixels corresponding to the portion that includes the region of interest also serves to crop the field of view in the raw video to the field of view in the second stream. In FIG. 10B, the second video stream shows a portion of the front area of the house that is cropped from the front area that is shown in the first video stream in FIG. 10A. The portion shown focuses on the region of interest 1002 corresponding to the unknown car.

In some implementations, playback of the first video stream may be resumed from the second video stream. For example, when the detected motion activity has ceased or another element enters the field of view, playback of the second video stream may cease and playback of the first video stream may resume. In this manner, the user may be shown the full field of view again, and/or the new element can be viewed in context of the full field of view.

Referring to FIG. 10C, the second stream has ceased playback, and the first stream has resumed playback on client device 504. In FIG. 10C, the driver of the car in region of interest 1002 has exited the car and is moving. The video server system 508 identifies a new region of interest 1004 based on the motion of the driver outside of the car.

Referring to FIG. 10D, the second stream has resumed playback on client device 504 in lieu of the first stream. The second stream now tracks region of interest 1004, as the car in region 1002 is not moving and the driver in region 1004 proceeds to engage in motion activity within the field of view (e.g., walking toward the package left on the porch). In FIG. 10D, the second stream again shows a portion of the front area of the house that is cropped from the front area that is shown in the first video stream (e.g., as in FIGS. 10A and 10C). The portion shown in FIG. 10D is different from the portion shown in FIG. 10B, as the second stream now tracks region of interest 1004.

Referring to FIG. 10E, the second stream continues playback on client device 504, as the second stream continues to track region of interest 1004. In FIG. 10E, the portion of the front area of the house that is shown has shifted compared to the portion shown in FIG. 10D, in order to track the driver reaching the porch and about to grab the package.

Referring to FIG. 10F, the second stream continues playback on client device 504, as the second stream continues to track region of interest 1004. In FIG. 10F, the portion of the front area of the house that is shown has shifted compared to the portions shown in FIGS. 10D-10E, in order to track the driver walking away from the porch with the package and walking toward the mailbox.

Referring to FIG. 10G, the second stream continues playback on client device 504, as the second stream continues to track region of interest 1004. In FIG. 10G, the portion of the front area of the house that is shown has shifted compared to the portions shown in FIGS. 10D-10F, in order to track the driver reaching the mailbox to steal mail from the mailbox. As shown in FIGS. 10D-10G, the portion of the field of view that is shown in the second stream changes (e.g., the cropping area pans, tilts, and/or zooms) to follow the motion activity with which region of interest 1004 is associated.

FIGS. 10A-10G shows the first and second streams playing in separate views on the client device 504; one stream plays in lieu of the other. In other words, the first stream and the second stream are played in separate views. As described above, in some implementations, the first and second streams may be played concurrently. FIGS. 10H-10K, described below, illustrate examples of the first stream and the second stream playing concurrently.

Referring to FIG. 10H, playback of the first video stream and the second video stream are presented concurrently on the client device 504. The first stream and the second stream are played side-by-side in a split screen mode, with the first stream playing on the left and the second stream playing on the right. The first stream is playing at a default scale level (e.g., the same scale level as if the first stream is playing without the split screen) on the left side of the split screen, and the region of interest 1004 is in view. The second stream is playing on the right side of the split screen, scaled to zoom in on the region of interest 1004, and is cropped to fit the right side of the split screen, with the region of interest 1004 in view (e.g., approximately centered). In this manner, the region of interest 1004 is kept in focus on both sides of the split screen).

Referring to FIG. 10I, playback of the first video stream and the second video stream are presented concurrently on the client device 504. The second stream is played in a floating or movable overlay 1006 over the playing first stream. The first stream is played at the default scale level and shows the full field of view, and the second stream playing in the overlay 1006 is cropped and scaled up, to keep the region of interest 1004 in focus. The overlay 1006 is positioned approximately over the position of the region of interest 1004 in the field of view of the first stream, and may follow the movement of the region of interest 1004 (i.e., the overlay 1006 moves along with the motion activity with which region of interest 1004 is associated). In this manner, the floating overlay 1006 and the second stream playing within behaves like a magnifying glass or loupe that is placed over the portion of the field of view that includes the region of interest 1004 and follows the motion activity associated with the region of interest 1004.

Referring to FIG. 10J, playback of the first video stream and the second video stream are presented concurrently on the client device 504. The second stream is played in a stationary overlay 1008 (e.g., a picture-in-picture view) over the playing first stream. The stationary overlay 1008 has a predefined size and area. The first stream is played at the default scale level and shows the full field of view, and the second stream playing in the overlay 1008 is cropped to keep at least a portion of the region of interest 1004 in view and in focus within the predefined size and area of the stationary overlay 1008. In some implementations, the overlay 1008 is positioned at a predefined corner region of the display area and is stationary. In some implementations, the overlay 1008 is positioned at a corner region of the display area and is generally stationary, but may be temporarily shifted to another corner region of the display area if detected motion activity in the playing first stream becomes obscured by the overlay 1008.

Referring to FIG. 10K, playback of the first video stream and the second stream are presented concurrently on the client device 504 in a picture-in-picture arrangement similar to that described above with reference to FIG. 10J. In FIG. 10K, the first video stream is played in a stationary overlay 1010 (e.g., a picture-in-picture view) over the playing second stream. The stationary overlay 1010 has a predefined size and area. The first stream is played at a scale that fits the full field of view in the predefined size and area of the stationary overlay 1010. In some implementations, the overlay 1010 is positioned at a corner region of the display area and is stationary. In some implementations, the overlay 1010 is positioned at a corner region of the display area and is generally stationary, but may be shifted to another corner region of the display area if detected motion activity in the playing second stream becomes obscured by the overlay 1010.

In some implementations, a transition effect or animation maybe shown when playback of the first stream transitions to playback of the second stream and vice versa (i.e., when playback of either stream is in lieu of the other), or when playback of the first stream transitions to concurrent playback of the first and second stream and vice versa (i.e., when the first and second streams may be played concurrent as in FIGS. 10H-10K). The transition effect or animation may be any suitable effect or animation to alert the user of the transition, such as a fade-out and fade-in effect.

In some implementations, separate sub-streams may be created for tracking regions 1002 and 1004. For example, the second stream described above may be continually associated with region 1002, and a third stream is created for region 1004. Which one of the second or third stream is played may depend on whether either associated region has on-going motion activity, priority levels associated with the regions, etc.

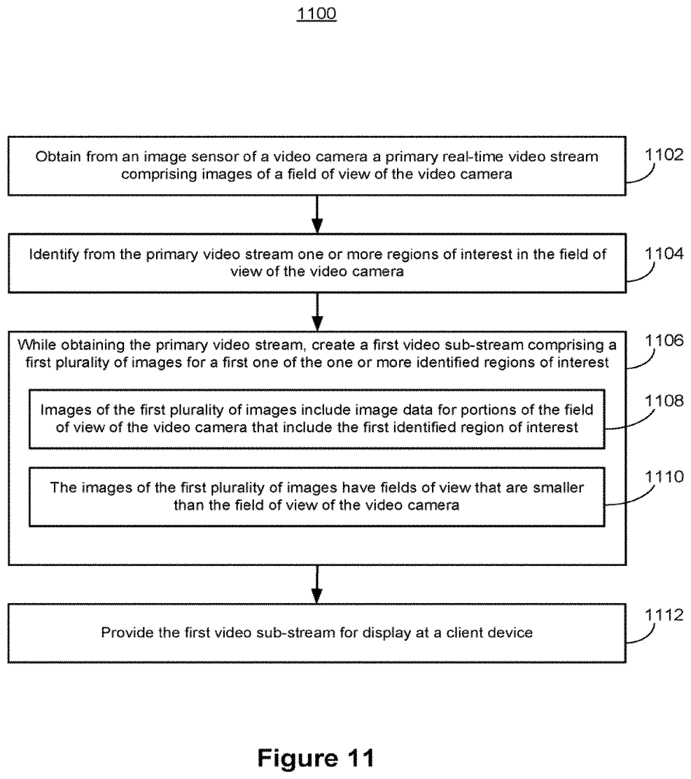

FIG. 11 illustrates a flowchart representation of a method 1100 of providing image data for detected regions of interest, in accordance with some implementations. In some implementations, the method 1100 is performed by one or more electronic devices of one or more systems (e.g., devices of a smart home environment 100 in FIGS. 1-9, such as a camera 118, client device 504, etc.) and/or a server system (e.g., video server system 508). Thus, in some implementations, the operations of the method 1100 described herein are interchangeable, and respective operations of the method 1100 are performed by any of the aforementioned devices, systems, or combination of devices and/or systems. As merely an example, in some implementations, a camera (rather than a server system) may detect or identify a region of interest in a video stream, and the camera (rather than the server system) performs operations for creating a sub-stream that includes images for an identified region of interest. As another example, in some implementations, an electronic device (e.g., a camera 118) or a server system (e.g., video server system 508) may perform the method 1100.

In some implementations, the method 1100 is performed by an electronic device with one or more processors and memory (e.g., a camera (e.g., camera 118, FIGS. 1 and 8), a server system (e.g., video server system 508, FIGS. 1 and 6), and/or a client device (e.g., client device 504, FIGS. 1 and 7)). In some implementations, operations in method 1100 correspond to instructions stored in computer memory or memories (e.g., memory 806 of camera 118, FIG. 8, memory 606 of video server system 508, FIG. 6, memory 706 of client device 504, FIG. 7, etc.) or other non-transitory computer-readable storage medium.

A primary real-time video stream comprising images of a field of view of a video camera is obtained from an image sensor of the video camera (1102). One or more video streams 900, including a primary stream, are obtained from the image sensor of a camera 118. The primary stream includes images of a field of view of the camera 118. For example, in FIG. 10A, the first video stream corresponds to the primary video stream, showing the front area of the house captured on video.

In some implementations, a camera 118 obtains the video stream(s) 900 by reading data from the image sensor(s) 816 of the camera 118 and generating the video stream(s) 900, including a primary stream, from the image sensor data. The camera 118 may perform processing on the image sensor data or the generated video stream(s) prior to transmission (e.g., to detect activity (e.g., motion) and elements (e.g., people, animals, objects) in the video streams).

In some implementations, a video server system 508 obtains the video streams 900 from the camera 118 for processing. For example, the camera 118 reads data from its image sensor(s) 816, and generates the video stream(s) 900, including a primary stream, from the image sensor data. The camera 118 transmits the stream(s) 900 to the video server system 508 via network(s) 162, and the video server system 508 receives the streams for processing.

In some implementations, a field of view for the images of the primary video stream is substantially equal in size to a field of view for a full frame. The field of view of the primary stream may correspond to the full field of view of the camera 118.

One or more regions of interest in the field of view of the video camera are identified from the primary video stream (1104). One or more regions of interest (e.g., regions of interest 1002, 1004) in the field of view are identified from the primary video stream amongst video stream(s) 900. In some implementations, the primary stream is also transmitted (e.g., by the video server system 508) to a client device 504 for playback (e.g., the first video stream described above in relation to FIGS. 10A-10K).

In some implementations, the camera 118 processes, prior to transmission to the video server system 508, the primary stream to detect activity (e.g., motion) and elements (e.g., people, animals) in the video. The camera 118 may identify a region of interest around a detected element engaging in detected activity.

In some implementations, the video server system 508 processes the primary stream received from the camera 118 to detect activity (e.g., motion) and elements (e.g., people, animals) in the video. The video server system 508 may identify a region of interest around a detected element engaging in detected activity.

In some implementations, one or more regions of interest in the field of view of the video camera are identified from the primary video stream in near real-time. For example, the camera 118 or video server system 508 (e.g., region of interest module 640) identifies the region(s) of interest from the primary stream as the primary stream is generated by the camera 118 or received by the video server system 508, respectively. The region(s) of interest may be identified based on motion activity, events, and elements detected in the primary video stream.

While the primary video stream is obtained, a first video sub-stream comprising a first plurality of images for a first one of the one or more identified regions of interest is created (1106), wherein images of the first plurality of images include image data for portions of the field of view of the video camera that include the first identified region of interest (1108), and the images of the first plurality of images have fields of view that are smaller than the field of view of the video camera (1110). While the primary stream continues to be obtained, a sub-stream (e.g., the second stream described above in relation to FIGS. 10A-10K) that includes images showing a portion of the field of view of the primary stream that includes the region of interest is generated. The portion shown in the sub-stream is cropped from the field of view of the video camera.

In some implementations, the camera 118, while continuing to generate and process the primary stream prior to transmitting the primary stream to the video server system 508, creates a sub-stream (e.g., a second video stream). The sub-stream may be created from image data in the primary stream. The sub-stream includes images that include a portion of the camera field of view that includes a region of interest. The fields of view of the images in the sub-stream are smaller than the camera field of view.

In some implementations, the video server system 508, while continuing to receive and process the primary stream from camera 118, creates a sub-stream (e.g., a second video stream). The sub-stream may be created from image data in the primary stream. The sub-stream includes images that include a portion of the camera field of view that includes a region of interest. The fields of view of the images in the sub-stream are smaller than the camera field of view.

In some implementations, the images of the first plurality of images include image data for portions of the field of view of the video camera that include the first identified region of interest, thereby tracking the first identified region of interest throughout the field of view of the video camera. For example, the second stream described above in relation to FIGS. 10A-10K tracks a region of interest as the corresponding motion activity occurs; the second stream shows frames that include the region of interest as the region of interest shifts with the detected moving element.

In some implementations, the images of the first plurality of images have a first image resolution that is greater than a resolution of the images of the primary video stream. For example, the second stream described above in relation to FIGS. 10A-10K may have a higher resolution than the first stream.

The first video sub-stream is provided for display at a client device. The first video sub-stream (e.g., the second stream) is transmitted to a client device 504, via network(s) 162, for playback in lieu of or concurrently with the first stream (e.g., the primary stream), as shown in FIGS. 10A-10K for example.

In some implementations, the camera 118 provides (e.g., transmits) the second stream created by the camera 118 to a video server system 508, which in turn transmits the second stream to a client device 504 for playback in lieu of or concurrently with the first stream (e.g., the primary stream).

In some implementations, the video server system 508 transmits the second stream created by the video server system 508 to a client device 504 for playback in lieu of or concurrently with the first stream (e.g., the primary stream).

In some implementations, images of the first plurality of images of the first video sub-stream are formatted for presentation in a first display window having a fixed size. For example, the second stream may be played in an area of predefined size (e.g., in a stationary overlay 1008, FIG. 10J; in a display area that occupies a substantial portion of the display of the client device 504), and is cropped and scaled for the area while keeping the region of interest in focus.

In some implementations, the primary video stream is provided for display at the client device, where the images of the primary video sub-stream are formatted for presentation in a second display window on which the first display window is overlaid. For example, in FIG. 10J, the second stream is played in a stationary overlay 1008 over the playing first stream. As another example, in FIG. 10I, the second stream is played in a floating overlay 1006 over the playing first stream, and the floating overlay 1006 moves along with the region of interest 1004 in the first stream.

In some implementations, as used herein, a field of view is defined as a portion (e.g., partial, entire) of a field of view for which images and/or video is captured by an image sensor. Thus, if a first image has a field of view that is smaller than the field of view of a second image, then the corresponding portion of the camera field of view captured and represented by the first image is larger than that of the second image when both are scaled to fit into the same predefined area. In some implementations, the field of view of the camera 118 is the field of view of the image sensor(s) 816, and a portion of the field of view of the camera 118 is a portion of the field of view of the image sensor(s) 816 (e.g., image data read from a subset of the pixels of the image sensor(s) 816).

In some implementations, identifying the one or more regions of interest includes detecting motion in an area of the field of the video camera corresponding to the first identified region of interest. The video stream(s) 900 may be processed by the camera 118 or the video server system 508 to detect motion. A region of interest in a portion of the field of view where the motion activity is detected may be identified. For example, the regions of interest 1002 or 1004 in FIGS. 10A-10K may be identified based on the motion activity of the car and the driver, respectively.

In some implementations, motion has been detected more than a threshold number of times in the first identified region of interest. A threshold number of times that motion is detected at an area of the field of view (more particularly, going into or out of the area) may be predefined, learned (e.g., from video/event history), etc. at the camera 118 or video server system 508. The camera 118 or video server system 508 may determine that a certain area of the field of view satisfies the threshold and determine that the area is a source (number of times motion detected going into the area satisfies the threshold) or sink (number of times motion detected going out of the area satisfies the threshold) of motion, and identify the source/sink area as a region of interest.

In some implementations, creating the first video sub-stream is in response to detecting motion in the area of the field of view of the video camera. For example, the camera 118 or video server system 508 may create the second stream showing a portion of the camera field of view in response to detecting motion in the portion (and correspondingly identifying a region of interest) in that portion.

In some implementations, the first identified region of interest corresponds to a person of interest. For example, region of interest 1004 in FIG. 10C corresponds to the driver after exiting the car.

In some implementations, identifying the one or more regions of interest comprises receiving a user selection corresponding to the first region of interest. The user may define the region of interest while reviewing a playing video stream. For example, while the first stream is playing on a touch screen of the client device 504 and the user is viewing the playing first stream, the user may define a region of interest by drawing the boundaries of the region of interest on the playing first stream shown on the touch screen. The client-side module 502 communicates the user-defined region of interest to the camera 118 and/or the video server system 508.

In some implementations, identifying the one or more regions of interest is based at least in part on received signals corresponding to potential events of interest occurring in the first region of interest. For example, the camera 118 or video server system 508 may identify a region of interest based on events (e.g., sounds, hazard conditions, etc.) detected in the field of view, which may be associated with motion activity and/or elements that are indicative of the event or may have triggered the event. A region of interest may be identified for the motion activity and/or elements associated with the event. The signals corresponding to detected events may be received from another smart device 204 that is associated with the same user or household or structure as the camera 118.

In some implementations, identifying the one or more regions of interest in the field of view of the video camera includes identifying multiple regions of interest having priority levels, including at least the first identified region of interest having a first priority level and a second identified region of interest having a second priority level. In some implementations, a region of interest may be assigned a priority level that affects whether, and sometimes in what order, corresponding video sub-streams are created. A priority level for a region of interest may be predefined (e.g., by a user), may be learned (e.g., based on user review history (if, for example, a user frequently inspects particular individuals/events while reviewing video recordings), based on video history, etc.), and/or based on presence of on-going or very recent (e.g., within the last second) activity (events, motion) and/or elements (e.g., individuals, objects) in the region. For example, as shown in FIG. 10C, multiple regions of interest 1002 and 1004 may be identified. Each of these multiple regions of interest may be assigned a priority level. The priority levels control, for example, whether a sub-stream is created and which sub-stream is played. As an example, in FIG. 10C, region 1004 may be assigned a higher priority than region 1002 because region 1004 is associated with on-going motion activity or that the video server system 508 has learned that the user frequently reviews persons and less so objects when reviewing video. As another example, region 1004 maybe assigned a higher priority than region 1002 because the user had previously specified that regions of interest associated with persons or faces get higher priority than regions of interest associated with objects.

In some implementations, the first priority level is greater than the second priority level, and the creation of a second video sub-stream for the second identified region of interest is forgone based on the first priority level being greater than the second priority level. In some implementations, a region of interest is classified (e.g., based on type of specific individual, object, event, motion, etc.) after the region has been detected and identified. Based on its classification, a corresponding priority level of the region of interest is determined or assigned, and subsequently used to determine whether (and optionally/alternatively, in what order) a corresponding sub-stream is created. The decision to create/order the sub-stream may be made if other regions of interest are detected during the same time. For example, priority levels are compared, and a decision to create both or only one sub-stream, and optionally an order in which they are created (e.g., create a first sub-stream first, then create a second sub-stream (after a predefined time has elapsed, only if the second region of interest is still present after elapsed time, only once the first region of interest is no longer active, etc.)) is made. In some implementations, a sub-stream may be created only if the designated priority level satisfies a threshold (e.g., threshold is user-defined, predefined, learned, etc.).

In some implementations, the second priority level is greater than the first priority level, and the second region of interest is identified after creating the first video sub-stream for the first identified region of interest. Based on the second priority level being greater than the first priority level, creation of the first video sub-stream may be ceased, and a second video sub-stream comprising a second plurality of images for the second identified region of interest may be created. For example, referring back to FIG. 10C, region 1004 is identified after the driver exits the car in region 1002, and region 1004 may be assigned a higher priority level due to one or more criteria (e.g., user predefinition, machine learning, presence of on-going or very recent activity). In accordance with the higher priority of region 1004, the camera 118 or video server system 508 ceases creation of the second stream associated with region 1002, and creates a third stream associated with region 1004 (and what is played in FIGS. 10D-10K would be this third stream tracking region 1004). Alternatively, in accordance with the higher priority of region 1004, the camera 118 or video server system 508 disassociates region 1002 from the second stream and associates region 1004 with the second stream, or associates the region 1004 with the second stream along with region 1002.

In some implementations, the primary video stream and the first video sub-stream are created from a source video stream that includes full-frame images captured by the image sensor. Full-frame image data is image data captured using all (or substantially all) physical pixels of the image sensor 816 (i.e., image sensor not cropped). In some implementations, the source video stream is raw, uncompressed image data. The first stream (the stream showing the full field of view) may be encoded directly from the full-frame image data or raw image data, and the sub-streams associated with respective regions of interest may be created by extracting image data corresponding to portions of the full field of view from the full-frame image data or the raw image data, and encoding the extracted image data.

In some implementations, creating the first video sub-stream comprises modifying fields of view for a first set of full-frame images of the source video stream to produce the first plurality of images for the first video sub-stream, thereby emulating a pan, tilt, and/or zoom by the image sensor. By modifying the field of view, pan, tilt, and zoom controls are emulated and a region of interest is tracked throughout the camera field of view without mechanically adjusting a position and configuration of the image sensor 816. In some implementations, each sequential frame of raw image data is cropped and compressed to create the first video sub-stream. The raw image data from the source video stream is distinct from the first plurality of images for the first video sub-stream in that the first video sub-stream includes only modified copies of the raw image data (i.e., the raw image data is unmodified). The field of view of the second (and additional) streams associated with a region of interest is a subset of the full field of view. The video in the second stream pans, tilts, and zooms the video of the source stream to track the associated region of interest and to keep the associated region of interest in focus.

In some implementations, modifying the fields of view comprises, for each full-frame image in the first set of full-frame images, adjusting a size of a field of view for the full-frame image, and adjusting a position of the field of view for the full-frame image with respect to the field of view of the video camera. In some implementations, the field of view is manipulated in accordance with predefined profiles (e.g., which define speed, delay, etc. of pan, tilt, and zoom, thus emulating different directing styles). In some implementations, the field of view is successively shrunk between frames to emulate a zoom in. In some implementations, the field of view is first shrunk (i.e., starts zoomed), and then gradually expands (e.g., slowly zooms out).

In some implementations, sizes of the fields of view for the first plurality of images are at least partially distinct. In some implementations, the first plurality of images forms a sequence of images, wherein an image in the sequence has a corresponding field of view that is smaller than a field of view of a preceding image in the sequence (i.e., gradual zoom in). In some implementations, an image in the sequence has a corresponding field of view that is larger than a field of view of a preceding image in the sequence (i.e., gradual zoom out). Within the second (or additional) video stream associated with a region of interest, the field of view may decrease or increase in size within the sequence of frames in the video stream (e.g., from frame to frame amongst at least some frames within the sequence). In this manner, a gradual zoom in/out effect may be simulated.

In some implementations, positions of the fields of view for the first plurality of images with respect to the field of view of the video camera correspond to the portions of the field of view of the video camera that include the first identified region of interest, and the positions of the fields of view are at least partially distinct. A sub-stream associated with a region of interest may track the movement of the region of interest throughout the scene. For example, in FIGS. 10D-10G, the second stream tracks the movement of region of interest 1004 throughout the field of view, and the portion of the field of view shown in each of FIGS. 10D-10G vary in order to track the region of interest 1004.

In some implementations, creating the first video sub-stream comprises reading image data out from less than the entire image sensor. In other words, the image sensor is cropped (e.g., reading out image data from select lines/columns/portions of the image sensor). The camera 118 or video server system 508 may create the second (or additional stream) associated with a region of interest by obtaining image data from particular portions of the image sensor 816 corresponding to the portion of the field of view that includes the region of interest.

In some implementations, a second video sub-stream distinct from the first video sub-stream is created, the second video sub-stream comprising a second plurality of images for a second one of the one or more identified regions of interest, wherein: images of the second plurality of images include image data for portions of the scene corresponding to the second identified region of interest, thereby tracking the second identified region of interest throughout the scene, the images of the second plurality of images have fields of view that are smaller than the field of view for the images of the primary video stream, and the images of the second plurality of images have a second image resolution that is greater than a resolution of the images of the primary video stream. For example, a second sub-stream is created for a second person that emerges into the scene. In some implementations, the second sub-stream is created while the first sub-stream is being created. For example, the camera 118 or video server system 508 may create distinct streams for regions of interest 1002 and 1004 in FIG. 10C. These distinct streams track region 1002 and 1004, respectively, and may be created concurrently by the camera 118 or video server system 508.

In some implementations, movement in a portion of the scene that does not correspond to the first region of interest is detected, wherein creating the first video sub-stream is performed in response to detecting the movement, and creating the first video sub-stream comprises expanding fields of view for subsequently produced images of the first plurality of images until an expanded field of view includes the detected movement. For example, if motion is detected in a cropped portion of the scene (e.g., a person enters the scene), the field of view for the first video sub-stream is expanded (i.e., zoomed out) to enable capture of the detected motion. For example, in FIGS. 10C-10E, movement by the driver (identified as in region 1004) outside of the car and away from region 1002 is detected. As an alternative to creating an additional stream or disassociating region 1002 from the second stream, region 1004 may be associated with the second stream along with region 1002, or a replacement second stream associated with both regions 1002 and 1004 is created. The portion of the field of view shown in the second stream associated with both region 1002 and 1004 is cropped from the full field of view to include both regions 1002 and 1004.

In some implementations, a stream showing a full or wide field of view and another stream showing activity in a region of interest may be played concurrently. For example, the first stream may show the full field of view (e.g., a wide 130-degree view) and the second view may zoom in on the region of interest. The concurrent playback may be shown as a picture-in-picture arrangement (e.g., as in FIG. 10J or 10K) or in a floating overlay arrangement (e.g., as in FIG. 10I).

In some implementations, the portion of the field of view in the stream associated with a region of interest automatically pans, tilts, and/or zooms to help track the activity in the region of interest.

In some implementations, the detected element for which a region of interest is identified (and thus may be zoomed in on in a stream associated with the region of interest) may be a person (e.g., detected stranger, detected known person), an animal (e.g., a pet), or an object (e.g., a car).

In some implementations, the detected motion includes motion starting from a region of interest and/or motion starting from an ingress/egress area. Detected motion may originate from a source area and/or terminate in a sink area, and the source/sink area may be identified as a region of interest based on motion originating or terminating in the area.

In some implementations, a region of interest may be identified based on automatic detection of objects in the field of view (e.g., region of interest created on mail package, region of interest created on car entering driveway); the region of interest is automatically identified based on the automatic object detection.

In some implementations, a region of interest is identified for a detected person or face associated with an automatically created region of interest (e.g., a stranger stealing a package taken out of an automatically created region of interest, a person entering or exiting a region of interest).

In some implementations, elements may be detected using various image recognition techniques and processes, and specific persons or objects, or types thereof, may be recognized. For example, persons and/or types of persons may be recognized using facial recognition, gait recognition, clothing/uniform recognition (e.g., recognition of a delivery person by the person's uniform), and other recognition based on appearance and/or motion. Objects and/or types of objects may be recognized based on shape, color, on-object text, and/or on-object graphics. For example, vehicle recognition (e.g., type of car, license plate, organization the vehicle belongs to) based on shape, on-vehicle livery, on-vehicle text, etc. may be performed. Further, in some implementations, the person recognition may inform the object recognition, and/or vice versa (e.g., a person exiting a recognized delivery company vehicle may be recognized as a delivery person).

In some implementations, image recognition (e.g., person recognition, object recognition) are performed by comparing images in the video against an image database. The image database (not shown) may be located at the video server system 508, camera 118, or client device 504. In some implementations, the image recognition is performed on raw video that is higher quality than the first or second streams.

In some implementations, the user may specify a whitelist of certain persons, types of persons, objects, or types of objects. Persons, objects, and/or types thereof in the whitelist that are recognized in the video are disregarded and not identified as regions of interest. Detected persons and objects not recognized as on the whitelist are identified as regions of interest and tracked. In some implementations, persons or objects that appear in the video and are recognized frequently over time (e.g., the user's car, members of the user's family) may be disregarded and not identified as regions of interest.

In some implementations, when a detected person or object that is not on the whitelist, not previously recognized before, or not frequently recognized is detected in the video, a video frame with the detected person or object may be saved and sent to a client device 504 with a prompt (e.g., in a message or notification) asking the user if the user knows the detected person or object. If the user's response is that he knows the detected person or object, the detected person or object may be disregarded and not identified as a region of interest. If the user's response is that he does not know the detected person or object, the detected person or object is identified as a region of interest and tracked. In some implementations, the frame sent to the user is extracted from raw video that is higher quality than the second stream and is zoomed-in to show the details of the person or object (e.g., zoomed-in on the face). In some implementations, the frame sent to the user is extracted from the second video stream.

In some implementations, a portion of the first stream may be generated as a video clip (which can then be saved and/or shared) in response to a user request. A portion of the second stream corresponding to the portion of the first stream (e.g., portion in the same time span as the portion of the first stream) may be saved with the video clip. In this manner, when the video clip is played later, a region of interest in the portion included in in the video clip may be tracked.

In some implementations, a frame of the first stream may be saved as a still image, and a frame from the second stream corresponding to the saved frame (e.g., frame with the same timestamp) from the first stream may be saved as a still image along with the frame from the first stream. Both frames may be sent to a client device 504 in a message or notification notifying the user of detected activity or a detected element.

In some implementations, objects detected in the field of view may be highlighted in the first stream and/or the second stream, regardless of whether or not the object is in the region of interest. For example, one or more objects may be detected in the field of view. Certain types of objects (e.g., packages, license plates on automobiles) may be predefined as objects of interest (e.g., predefined by the user), and when detected, may be highlighted to bring them to the user's attention. The highlighting is shown in the playing first stream and/or second stream as, for example, a highlight or glow around the object.

In some implementations, audio data corresponding to audio captured by an audio input device associated with the image sensor is obtained; the audio data is provided to the client device; a source of the audio in the field of view of the video camera is detected, wherein the source is a person or an animal; a region of interest associated with the source of the audio is identified; a second video sub-stream comprising a second plurality of images for the regions of interest associated with the source of the audio is created, wherein: images of the second plurality of images include image data for portions of the field of view of the video camera that include the region of interest associated with the source of the audio, and the images of the second plurality of images have fields of view that are smaller than the field of view of the video camera; and the second video sub-stream is provided for display at a client device. In some implementations, while the first stream and/or the second stream are being played on client device 504, audio may be exchanged between the client device 504 and the camera 118 (e.g., via video server system 508 and network 162) concurrent with playback of the first stream and/or the second stream, thus facilitating audio (e.g., voice) communication between a user of the client device 504 and persons and animals in the field of view of camera 118. For example, both client device 504 and camera 118 may include audio input (e.g., microphone) and audio output (e.g., speaker) devices, and memory 706 of the client device 504 and memory 806 of camera 118 may include respective modules or sub-modules (not shown) for handling audio input and output. At the client device 504, the user may activate an audio communication functionality of the client module 504 (e.g., activate a “talk and listen” feature or the like in an application associated with the client-side module 502). The camera 118 captures audio from its proximity and transmits the corresponding audio data to the video server system 508. The video server system 508 transmits the camera audio data to the client device 504 for output. The client device 504 captures audio in its proximity (e.g., the user trying to speak to the person in the field of view of the camera 118) and transmits the corresponding audio data to the video server system 508. The video server system 508 transmits the client audio data to the camera 118 for output. Further, in some implementations, while the “talk and listen” feature is active, a stream that tracks the person or animal that “talks” to the user is generated; a region of interest that includes the person or animal is defined, and the generated stream tracks this region of interest. The stream tracking the person/animal talking to the user may be played in lieu of or concurrently with the first stream in a similar manner as the second stream described above with reference to FIGS. 10A-10K. In some implementations, objects that make sounds may also be tracked as regions of interest in second and additional streams.

In some implementations, the raw video has a higher resolution than the first and the second streams. For example, as described elsewhere in this specification, the raw video may be 4K video, and the first and second streams are 1080p. In this manner, the raw video may be cropped for generation of the second stream, for processing, for extraction, etc.; and the cropped portion can still have enough pixels for 1080p resolution or otherwise high quality for processing or user-review purposes.

As described above, operations of the method 1100 described herein are interchangeable, and respective operations of the method 1100 may be performed by any of the aforementioned devices, systems, or combination of devices and/or systems. As an example, in some implementations, the camera performs any or all of the operations described with respect to the server system, such as identifying from the primary video stream one or more regions of interest (step 1104), and creating a first video sub-stream (step 1106) comprising a first plurality of images for a first one of the one or more identified regions of interest. Therefore, any operations performed between the client device and server system, and between the server system and client device, may be performed analogously between the camera and the client device.

It should be understood that the particular order in which the operations in FIG. 11 have been described is merely an example and is not intended to indicate that the described order is the only order in which the operations could be performed. One of ordinary skill in the art would recognize various ways to reorder the operations described herein.

For situations in which the systems discussed above collect information about users, the users may be provided with an opportunity to opt in/out of programs or features that may collect personal information (e.g., information about a user's preferences or usage of a smart device). In addition, in some implementations, certain data may be anonymized in one or more ways before it is stored or used, so that personally identifiable information is removed. For example, a user's identity may be anonymized so that the personally identifiable information cannot be determined for or associated with the user, and so that user preferences or user interactions are generalized (for example, generalized based on user demographics) rather than associated with a particular user.

Although some of various drawings illustrate a number of logical stages in a particular order, stages which are not order dependent may be reordered and other stages may be combined or broken out. Furthermore, in some implementations, some stages may be performed in parallel and/or simultaneously with other stages. While some reordering or other groupings are specifically mentioned, others will be apparent to those of ordinary skill in the art, so the ordering and groupings presented herein are not an exhaustive list of alternatives. Moreover, it should be recognized that the stages could be implemented in hardware, firmware, software, or any combination thereof.

Reference has been made in detail to implementations, examples of which are illustrated in the accompanying drawings. In the above detailed description, numerous specific details are set forth in order to provide a thorough understanding of the various described implementations. However, it will be apparent to one of ordinary skill in the art that the various described implementations may be practiced without these specific details. In other instances, well-known methods, procedures, components, circuits, and networks have not been described in detail so as not to unnecessarily obscure aspects of the implementations.

It will also be understood that, although the terms first, second, etc. are, in some instances, used herein to describe various elements, these elements should not be limited by these terms. These terms are only used to distinguish one element from another. For example, a first sub-stream could be termed a second sub-stream, and, similarly, a second sub-stream could be termed a first sub-stream, without departing from the scope of the various described implementations. The first sub-stream and the second sub-stream are both sub-streams, but they are not the same sub-stream.

The terminology used in the description of the various described implementations herein is for the purpose of describing particular implementations only and is not intended to be limiting. As used in the description of the various described implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

It is to be appreciated that “smart home environments” may refer to smart environments for homes such as a single-family house, but the scope of the present teachings is not so limited. The present teachings are also applicable, without limitation, to duplexes, townhomes, multi-unit apartment buildings, hotels, retail stores, office buildings, industrial buildings, and more generally any living space or work space.

It is also to be appreciated that while the terms user, customer, installer, homeowner, occupant, guest, tenant, landlord, repair person, and the like may be used to refer to the person or persons acting in the context of some particularly situations described herein, these references do not limit the scope of the present teachings with respect to the person or persons who are performing such actions. Thus, for example, the terms user, customer, purchaser, installer, subscriber, and homeowner may often refer to the same person in the case of a single-family residential dwelling, because the head of the household is often the person who makes the purchasing decision, buys the unit, and installs and configures the unit, and is also one of the users of the unit. However, in other scenarios, such as a landlord-tenant environment, the customer may be the landlord with respect to purchasing the unit, the installer may be a local apartment supervisor, a first user may be the tenant, and a second user may again be the landlord with respect to remote control functionality. Importantly, while the identity of the person performing the action may be germane to a particular advantage provided by one or more of the implementations, such identity should not be construed in the descriptions that follow as necessarily limiting the scope of the present teachings to those particular individuals having those particular identities.

The foregoing description, for purpose of explanation, has been described with reference to specific implementations. However, the illustrative discussions above are not intended to be exhaustive or to limit the scope of the claims to the precise forms disclosed. Many modifications and variations are possible in view of the above teachings. The implementations were chosen in order to best explain the principles underlying the claims and their practical applications, to thereby enable others skilled in the art to best use the implementations with various modifications as are suited to the particular uses contemplated.

1. A method of presenting image data, the method comprising:
obtaining, via at least a Wi-Fi network and at a cloud-based computing system configured to process motion events for each of a plurality of smart-home environments that are remote from the cloud-based computing system, a real-time video and audio stream comprising images of a field of view of a smart-home environment by a video camera that monitors the smart-home environment, the smart home environment corresponding to a distinct set of one or more video cameras, registered users, and client devices;
identifying from the video and audio stream a first region of interest of the smart-home environment in the field of view of the video camera;
while obtaining the video and audio stream, creating a first video sub-stream comprising a first plurality of images for the first identified region of interest of the smart-home environment;
based on an event recognition:
identifying from the video stream a second region of interest of the smart-home environment in the field of view of the video camera, the second region of interest of the smart-home environment being a smaller portion of the field of view of the video camera than the first region of interest of the smart-home environment;
creating a second video sub-stream comprising a second plurality of images for the second identified region of interest of the smart-home environment; and
concurrently providing the first video sub-stream and the second video sub-stream for display at a client device, of a registered user, that remotely monitors the smart-home environment, the first video sub-stream being displayed smaller in size than the second video sub-stream and the first video sub-stream being displayed in an overlay over the second video sub-stream.

2. The method of claim 1, wherein the concurrently providing the first video sub-stream and the second video sub-stream for display at the client device further comprises:
displaying the second video sub-stream at a default scale level of the client device; and
displaying the first video sub-stream at a predefined size and overlaid at a predefined location.

3. The method of claim 2, further comprising:
detecting that the display of the second video sub-stream obstructs motion in the display of the first video sub stream; and
based on the detecting, shifting the location of the displayed first video sub-stream.

4. The method of claim 1, wherein the second video sub-stream appears zoomed-in as compared to the first video sub-stream.

5. The method of claim 1, wherein the event recognition includes visual event recognition, motion event recognition, or audio event detection.

6. The method of claim 5, wherein the event recognition is the visual event recognition, and wherein the visual event recognition comprises:
recognizing a visual element in the real-time video stream.

7. The method of claim 6, wherein the recognizing the visual element in the real-time video stream comprises:
recognizing a person.

8. The method of claim 7, wherein the recognizing the person comprises:
recognizing one or more of a face of the person, a gait of the person, or clothing or a uniform of the person.

9. The method of claim 7, wherein the second identified region of interest corresponds to the person.

10. The method of claim 1, further comprising:
panning, tilting, or zooming to follow the second region of interest.

11. A cloud-based computing system configured to process motion events for each of a plurality of smart-home environments remote from the cloud-based computing system, the cloud-based computing system comprising:
one or more processors; and
memory comprising instructions executable by the one or more processors to cause the cloud-based computing system to:
obtain, via at least a Wi-Fi network, a real-time video and audio stream comprising images of a field of view of a smart-home environment by a video camera that monitors the smart-home environment, the smart home environment corresponding to a distinct set of one or more video cameras, registered users, and client devices;
identify from the video and audio stream a first region of interest of the smart-home environment in the field of view of the video camera;
while obtaining the video and audio stream, create a first video sub-stream comprising a first plurality of images for the first identified region of interest of the smart-home environment;
based on an event recognition:
identify from the video stream a second region of interest of the smart-home environment in the field of view of the video camera, the second region of interest of the smart-home environment being a smaller portion of the field of view of the video camera than the first region of interest of the smart-home environment;
create a second video sub-stream comprising a second plurality of images for the second identified region of interest of the smart-home environment; and
concurrently provide the first video sub-stream and the second video sub-stream for display at a client device, of a registered user, that remotely monitors the smart-home environment, the first video sub-stream being displayed smaller in size than the second video sub-stream and the first video sub-stream being displayed in an overlay over the second video sub-stream.

12. The cloud-based computing system of claim 11, wherein the instructions to concurrently provide the first video sub-stream and the second video sub-stream for display at the client device are further executable by the one or more processors to configure the cloud-based computing system to:
display the second video sub-stream at a default scale level of the client device; and
display the first video sub-stream at a predefined size and overlaid at a predefined location.

13. The cloud-based computing system of claim 12, wherein the instructions are further executable by the one or more processors to configure the cloud-based computing system to:
detect that the display of the second video sub-stream obstructs motion in the display of the first video sub stream; and
based on the detection, shift the location of the displayed first video sub-stream.

14. The cloud-based computing system of claim 11, wherein the second video sub-stream appears zoomed-in as compared to the first video sub-stream.

15. The cloud-based computing system of claim 11, wherein the event recognition includes visual event recognition, motion event recognition, or audio event detection.

16. The cloud-based computing system of claim 15, wherein the event recognition is the visual event recognition, and wherein the visual event recognition comprises:
recognition of a visual element in the real-time video stream.

17. The cloud-based computing system of claim 16, wherein the instructions to recognize the visual element in the real-time video stream are further executable by the one or more processors to configure the cloud-based computing system to:
recognize a person.

18. The cloud-based computing system of claim 17, wherein the instructions to recognize the person are further executable by the one or more processors to configure the cloud-based computing system to:
recognize one or more of a face of the person, a gait of the person, or clothing or a uniform of the person.

19. The cloud-based computing system of claim 17, wherein the second identified region of interest corresponds to the person.

20. The cloud-based computing system of claim 11, wherein the instructions are further executable by the one or more processors to configure the cloud-based computing system to:
pan, tilt, or zoom to follow the second region of interest.
